(19) United States
(12) Patent Application Publication
(10) Pub. No.: US 2021/0233187 A1
(43) Pub. Date: Jul. 29, 2021

(54) SYSTEMS, METHODS, AND APPARATUSES FOR TRAVEL PLANNING AND SELLING INVESTMENT PROPERTIES

(71) Applicant: J&M IP LLC, Morgan, UT (US)

(72) Inventors: Jerry Pierce, Morgan, UT (US); Mauricio Melendez, Morgan, UT (US)

(21) Appl. No.: 17/160,702

(22) Filed: Jan. 28, 2021

Related U.S. Application Data
(60) Provisional application No. 62/967,024, filed on Jan. 28, 2020.

(51) Int. Cl. G06Q 50/14; G06Q 30/02; G06Q 10/10; G06Q 10/02; G06Q 30/06; G06Q 20/40; G06Q 30/04; G06Q 10/06; G06F 16/9535; G06F 16/955; G06F 16/23

(52) U.S. Cl. CPC G06Q 50/14; G06Q 30/0201; G06Q 10/105; G06Q 10/02; G06Q 30/0645; G06Q 30/0613; G06Q 50/30; G06Q 20/40155; G06Q 30/04; G06Q 10/063112; G06F 16/9535; G06F 16/9558; G06F 16/2379; G06Q 30/0623

(57) ABSTRACT

Systems, methods, and apparatuses for planning and booking travel, lodging, and excursions, for offering travel, lodging, and excursions, and for selling investment properties may include: a client device having installed thereon a client application; a server device having installed thereon a server application; a database device having installed thereon a database application; and application logic of the client application, the server application, or the database application. The application logic may include instructions for: creating a user account, wherein the user account comprises a consumer account, a travel agent account, a host account, or an administrator account; creating a travel listing; or generating a private session, wherein, during the private session, an authenticated consumer user can create a travel itinerary, or an authenticated travel agent user can create and view a travel itinerary for a consumer account associated with the travel agent account.

### CROSS-REFERENCES

The present application claims the benefit of U.S. Provisional Patent Application No. 62/967,024 entitled “SYSTEMS, METHODS, AND APPARATUSES FOR TRAVEL PLANNING AND SELLING INVESTMENT PROPERTIES,” filed on Jan. 28, 2020. The entire contents of the above-listed application are hereby incorporated by reference for all purposes.

### BACKGROUND

The travel industry encompasses travel such as air travel, rail travel, bus travel, and/or sea travel; lodging such as hotels, resorts, bed and breakfasts, and private residences; and excursions such as events, activities, and/or entertainment. An individual planning a vacation and/or business travel may need to access a variety of resources such as internet sites, travel agencies, and/or individual excursion companies to plan an itinerary. Information about the itinerary may be provided to the individual in a variety of formats, including emails, PDFs, handbills, and so forth. A travel agent planning travel on behalf of an individual and/or group may face similar challenges. An individual or company that wishes to host travelers, such as by providing lodging and/or excursions, may use a variety of online platforms to advertise. The platforms may not communicate with each other, which may lead to double-booking and/or overbooking. Furthermore, individuals and/or companies that want to buy and/or sell investment properties for hosting travelers may have challenges providing and/or accessing information regarding the value of an investment property for hosting travelers.

### BRIEF DESCRIPTION OF DRAWINGS

The present description will be understood more fully when viewed in conjunction with the accompanying drawings of various examples of systems, methods, and apparatuses for planning and booking travel, lodging, and excursions, for offering travel, lodging, and excursions, and for selling investment properties. The description is not meant to limit the systems, methods, and apparatuses to the specific examples. Rather, the specific examples depicted and described are provided for explanation and understanding of systems, methods, and apparatuses for planning and booking travel, lodging, and excursions, for offering travel, lodging, and excursions, and for selling investment properties. Throughout the description, the drawings may be referred to as drawings, figures, and/or FIGs.

FIG. 1 illustrates a device network for a travel booking system, according to an embodiment.

FIG. 2 illustrates a landing page of the travel booking system, according to an embodiment.

FIG. 3A illustrates a consumer registration page of the travel booking system, according to an embodiment.

FIG. 3B illustrates a host/agent registration page of the travel booking system, according to an embodiment.

FIG. 3C illustrates a post-registration landing page for an agent user and/or an administrator user, according to an embodiment.

FIG. 4 illustrates a profile page of a travel booking system, according to an embodiment.

FIG. 5A illustrates a host dashboard, according to an embodiment.

FIG. 5B illustrates a first section of a property listing view available to a host user in the travel booking system, according to an embodiment.

FIG. 5C illustrates a second section of a property listing view available to a host user in the travel booking system, according to an embodiment.

FIG. 5D illustrates a third section of a property listing view available to a host user in the travel booking system, according to an embodiment.

FIG. 6 illustrates an agent dashboard of the travel booking system, according to an embodiment.

FIG. 7A illustrates a consumer dashboard of the travel booking system, according to an embodiment.

FIG. 7B illustrates a trip itinerary page of the travel booking system, according to an embodiment.

FIG. 7C illustrates an excursion listings page of the travel booking system, according to an embodiment.

FIG. 7D illustrates an agent listings page of the travel booking system, according to an embodiment.

FIG. 7E illustrates an agent request form of the travel booking system, according to an embodiment.

FIG. 8A illustrates a first section of a property listings search page of the travel booking system, according to an embodiment.

FIG. 8B illustrates a second section of the property listings search page of the travel booking system, according to an embodiment.

FIG. 8C illustrates a property listing page of the travel booking system, according to an embodiment.

FIG. 8D illustrates an excursion information page of the travel booking system, according to an embodiment.

FIG. 9 illustrates a share page for sharing a travel itinerary in the travel booking system, according to an embodiment.

FIG. 10A illustrates a first page of an administrator dashboard of the travel booking system, according to an embodiment.

FIG. 10B illustrates a second page of the administrator dashboard of the travel booking system, according to an embodiment.

FIG. 11 illustrates a method, executable by a processing device, of generating graphical interfaces for travel agents and travel guests in the travel booking system and pairing a travel guest and travel agent, according to an embodiment.

FIGS. 12A-B illustrate a method for pairing a travel agent profile with a travel guest profile and enabling a travel itinerary displayed via a graphical interface at a user device to be updated from another user device, according to an embodiment.

FIGS. 13A-B illustrate a method of receiving and accepting a pairing request, and subsequently enabling sharing of a common travel itinerary at devices associated with the paired profiles, according to an embodiment.

FIG. 14 illustrates a method for automatically pairing a travel agent profile and a travel guest profile, according to an embodiment.

FIG. 15 illustrates a method of browsing a plurality of profiles, according to an embodiment.

FIG. 16 illustrates a method of searching a set of user profiles using a search filter, according to an embodiment.

FIG. 17 illustrates a method of adding third-party excursion data to travel data in the travel booking system, according to an embodiment.

FIG. 18 illustrates a method of automatically disbursing a travel agent commission, according to an embodiment.

FIG. 19 illustrates a method of automatically generating an invoice when at least a portion of a travel itinerary is confirmed, according to an embodiment.

FIG. 20 illustrates a method of listing a vacation rental property for sale in the travel booking system, according to an embodiment.

FIG. 21 illustrates a method of using other trips booked by a travel agent to fill a current travel itinerary, according to an embodiment.

FIG. 22 illustrates a method of generating payment data to pay various entities associated with a travel itinerary, according to an embodiment.

### DETAILED DESCRIPTION

Systems, methods, and apparatuses for travel planning and selling investment properties as disclosed herein will become better understood through a review of the following detailed description in conjunction with the figures. The detailed description and figures provide merely examples of the various embodiments of systems, methods, and apparatuses for planning and booking travel, lodging, and excursions, for offering travel, lodging, and excursions, and for selling investment properties. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional travel booking system may include options for an individual to book lodging, travel, and/or excursions. Some travel booking systems allow individuals to book travel bundles, where lodging, travel, and/or excursions are booked simultaneously. Some travel booking systems offer homes and/or personal residences for travelers to book as lodging. Some travel booking systems allow individuals and/or businesses to offer homes, stand-alone residences, and/or rooms in homes and/or stand-alone residences to travelers as lodging. Such travel booking systems allow travelers to connect with private hosts, arrange travel dates and party size, negotiate price, and/or communicate with hosts once the lodging has been booked. As one example, an individual may offer to host a traveler in a room in their home on such a travel booking system. A traveler may select to book a room in a host's home or an entire residence. Conventional travel booking systems may also allow a traveler to directly book air travel, rent a car, book a cruise, and so forth.

However, conventional travel booking systems do not allow an individual to leverage the knowledge, experience, and/or resources of a travel agent. A travel agent may have special knowledge about travel, lodging, and excursions in a particular area that may not be readily known by an inexperienced traveler. For example, the travel agent may know the best days and/or times to book an international flight, which information may escape the inexperienced traveler or may take a significant amount of time for the inexperienced traveler to learn. The travel agent may have information on excursions at various destinations, may have information on the best lodging opportunities, and/or may know how to plan an optimal itinerary to maximize the travelers' objectives for travel. Additionally, there is currently a dearth of information on the value of a travel-hosting investment property. For example, an individual and/or business that seeks to invest in a travel-hosting property such as a home in a popular destination city may have to speculate on information such as how likely the home is to be booked during a particular season, how much can be charged for a booking, and so forth. Such information may be collected individually by owners but may be difficult and/or impossible to verify.

Systems, methods, and apparatuses for travel planning and selling investment properties are disclosed herein that address the issues with the travel booking industry described above, in addition to providing other advantages. A travel booking system as described herein may include an unregistered user module, a registered consumer module, a travel agent module, a host module, and/or an administrator module. The unregistered user module may allow an unregistered user to browse short-term rental properties and excursions available near the short-term rental properties. The registered consumer module may allow a registered consumer to browse and/or book short-term rental properties and/or excursions, to select and/or communicate with a travel agent, to build and/or view a travel itinerary, and/or to browse and/or purchase short-term rental properties offered for sale. The travel agent module may allow a registered travel agent to book short-term rental properties and/or excursions on behalf of a consumer, build and/or view a travel itinerary on behalf of the consumer, and/or communicate with the consumer. The host module may allow a host to list a property for short-term rental and/or to list a short-term rental property for sale. The administrator module may allow an administrator to moderate users and/or content made available through the travel booking system.

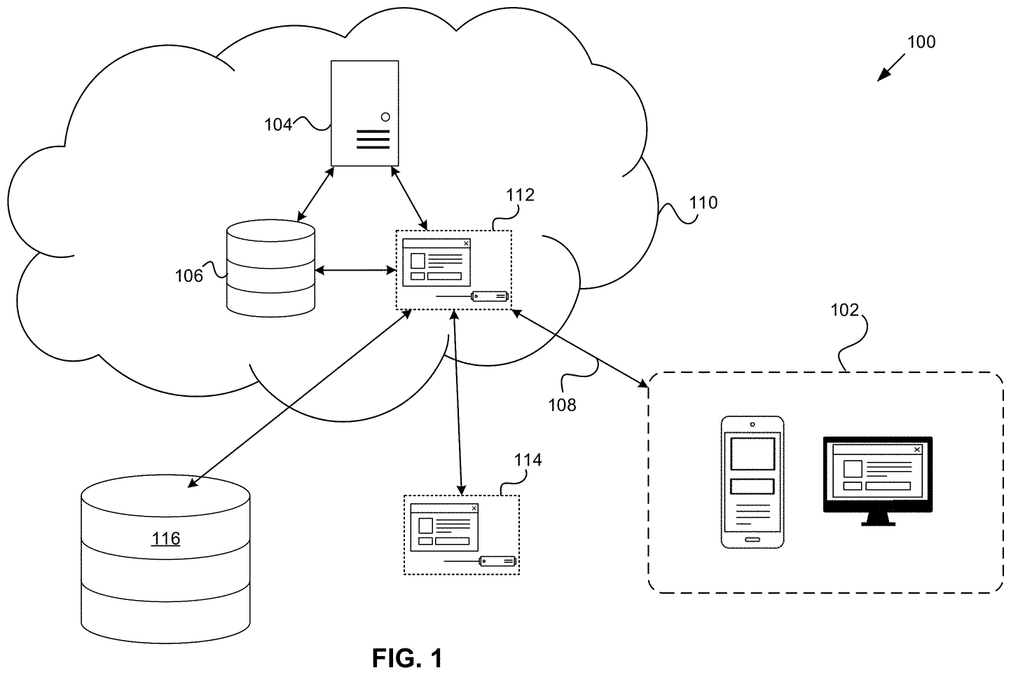

FIG. 1 illustrates a device network 100 for a travel booking system, according to an embodiment. The travel booking system may bring together a travel agent and a travel guest in a single, seamless system. The travel booking system may enable the travel agent and the travel guest to view vacation rentals, transportation, and excursions in the same application. The travel booking system may enable the travel guest to view rentals, excursions, and/or transportation and identify in the system to the travel agent which rentals, excursions, and/or transportation the travel guest prefers. The travel agent may also view rentals, excursions, and/or transportation and recommend, in the travel booking system, an itinerary for the travel guest. The travel guest profile may be linked to the travel agent profile so that both parties may build a travel itinerary for the travel guest, book travel, pay for the travel bookings, and allow the travel agent to directly collect commissions.

The device network 100 may include a client device 102, a server device 104, and/or a database device 106. Various of the elements of the device network 100 may communicate via communication links 108. The communication links may be direct or indirect. The client device 102 may have installed thereon a travel booking client application. The server device 104 may have installed thereon a travel booking server application. The database device 106 may have installed thereon a travel booking database application.

The server device 104 and/or the database device 106 may be part of a cloud-based network 110. The client device 102 may communicate with the server device 104 and/or the database device 106 via an application server 112. The application server 112 may also facilitate communication of the server device 104 and/or the database device 106 with an external application 114 and/or an external database 116. For example, the external application 114 may be an excursion booking system. As another example, the external database 116 may be an airline travel database.

The client device 102 may include a device such as a mobile phone, a smartphone, a tablet computer, a desktop computer, and so forth. In an embodiment, the client application may include software installed on the client device 102 such as a mobile application, a desktop application, a web browser, and so forth. The server device 104 may include a first bare metal server, a first virtual server, and so forth. In an embodiment, the server application may include software installed on the server device 104 such as application server software, web server software, file server software, and so forth. The database device 106 may include a second bare metal server, a second virtual server, and so forth. In an embodiment, the database application may include software installed on the database device 106 such as structured query language (SQL) software, non-SQL software, database management software, and so forth.

The client device 102 may include a memory device and/or a processing device. The client memory device may store source code for the client application. The client processing device may execute the client application source code to send information, request information, and/or display information to a user of the client device. In an embodiment, the client memory device and the client processing device may be physically separate devices. In another embodiment, the client memory device and the client processing device may be integrated into the same physical device.

The device network 100 may include multiple client devices 102 that are associated with different users and/or different types of users of the travel booking system. For example, one client device 102 may be associated with the travel agent. The client device 102 may run a client-side instance of the travel booking system associated with a travel agent profile stored in the database device 106. Another instance of the client device 102 may be associated with the travel guest. The client device 102 may run a client-side instance of the travel booking system associated with a travel guest profile stored in the database device 106.

The server device 104 may include a server memory device and/or a server processing device. The server memory device may store source code for the server application. The server processing device may execute the server application source code to send information to the client device 102 or the database device 106, to receive information from the client device 102 or the database device 106, to open and close authenticated sessions, to authenticate and/or authorized information requests from the client device 102, and so forth. In an embodiment, the server memory device and the server processing device may be physically separate devices. In another embodiment, the server memory device and the server processing device may be integrated in the same physical device.

The database device 106 may include a database memory device and/or a database processing device. The database memory device may store source code for the database application. The database memory device may store data, information, and/or content organized by the database application. The database processing device may execute the database application source code to organize the data, information, and/or content. In an embodiment, the database memory device and the database processing device may be physically separate devices. In another embodiment, the database memory device and the database processing device may be integrated in the same physical device.

In an embodiment, the processing devices may have non-transitory and/or transitory memory, and the memory devices may have non-transitory and/or transitory memory. For example, the processing devices may have transitory memory and the memory devices may have persistent, non-transitory memory. The processing devices may generate an output based on an input. For example, the client processing device may receive an electronic and/or digital signal from a client user interface. The client processing device may generate a digital signal output based on the digital signal received from a client user interface and may transmit the digital signal output to the client memory device. The client memory device may store the digital signal output. In an embodiment, the client processing device may receive a digital signal from a client networking chip. The digital signal may correspond to information received by the client device 102 from the server device 104. The client processing device may generate a display output based on the digital signal received from the server device 104, and the client user interface may display the information to the user.

In an embodiment, the processing devices may include a microprocessor, a computer processing unit (CPU), a graphics processing unit (GPU), a vision processing unit, a tensor processing unit, a neural processing unit, a physics processing unit, a digital signal processor, an image signal processor, a synergistic processing element, a field-programmable gate array (FPGA), a sound chip, a multi-core processor, and so forth. In an embodiment, the memory devices may include a random-access memory (RAM) device, a dynamic RAM device, a static RAM device, a read-only memory (ROM) device, a flash memory device, a programmable ROM device, an erasable programmable ROM device, and so forth. As used herein, “processor,” “processing component,” “processing device,” “processing unit,” “memory device,” and/or “memory component” may be used generically herein to refer to any or all of the aforementioned specific devices.

In an embodiment, the client application may include a mobile client application for displaying information associated with the travel booking system on a mobile device, a web client application for displaying information associated with the travel booking system in a web browser, and/or a desktop client application for displaying information associated with the travel booking system on a personal computer. The client application may communicate with the server application via the first network communication link 108a. The server application may handle communications from the client application and/or may interact with the database application via the second network communication link 108b based on the communications from the client application.

The client application may include application logic for interacting with the server application and user interface (UI) elements that allow the user to request, input, and/or view information managed by the database application. The server application may include application logic for handling communications from the client application, for authenticating and/or determining an authorization of a user of the client application, and/or for passing information, data, and/or content between the client application and the database application. The database application may include data structures and/or application logic for organizing information, data, and/or content associated with the travel booking system.

For example, the client application may include search logic, a search UI, and/or a search results UI. The search logic may include instructions to send a request to the server application for information based on a search query generated by the user using the search UI. The server application may create a session for the search query, may retrieve the requested information from the database application, and may send the requested information to the client application. The search results UI of the client application may display the requested information to the user. Other pages of the client application may include other application logic and/or other UI elements. The logic and/or UI elements of a particular client application may vary depending on the type of device associated with the client application. For example, a web client application may include different logic and/or UI elements than a mobile client application.

The client device 102 on which the client application runs may be physically located remotely from the server device 104 and/or the database device 106. Accordingly, in an embodiment, the client device 102 may include client communication hardware, the server device 104 may include server communication hardware, and/or the database device 106 may include database communication hardware. In an embodiment, the communication hardware may include a networking chip, an antenna, an optical transceiver, and/or a communication port. The networking chip may generate electronic signals and transmit the electronic signals to the antenna. The networking chip may receive electronic signals from the antenna. The network chip may transceive electronic signals via the antenna. The antenna may broadcast radio frequency (RF) signals based on the electronic signals from the networking chip. The antenna may receive RF signals and generate electronic signals based on the received RF signals. The antenna may communicate the electronic signals to the networking chip. The networking chip may generate digital electronic signals and transmit the digital electronic signals to the communication port. The networking chip may receive digital electronic signals from the communication port. The digital electronic signals may be transmitted to and/or received from a communication hardline by the communication port. The networking chip may transmit electronic signals to the optical transceiver. The networking chip may receive electronic signals from the optical transceiver. The optical transceiver may generate and/or transmit optical signals based on the electronic signals from the networking chip. The optical transceiver may generate electronic signals based on optical signals received by the optical transceiver.

In various embodiments, the communication hardware may include hardware and/or software for generating and communicating signals over a direct and/or indirect network communication link. For example, the communication hardware may include a universal serial bus (USB) port and a USB wire, and/or an RF antenna with Bluetooth™ programming installed on the networking chip. In another example, the communication hardware may include an RF antenna and programming installed on the networking chip for communicating over a Wifi and/or cellular network. As used herein, “communication device” and/or “communication component” may be used generically herein to refer to any or all of the aforementioned elements and/or features of the communication component.

The client device, the first server device, and/or the second server device may be networked together in a communication network. The communication network may include a local area network (LAN), a campus-area network (CAN), a metropolitan area network (MAN), a wide area network (WAN), an internet area network (IAN), a cellular network, a public Internet network, or combinations thereof. The communication network may include two or more network types. For example, the communication network may include the cellular network and the Internet.

The communication link 108 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding a network communication link, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding a network communication link, may refer to any of the aforementioned indirect communication links.

In an embodiment, the server device 104 and the database device 106 may be virtual servers on the same bare-metal server. In another embodiment, the server device 104 and the database device 106 may be separate bare-metal servers in the same server farm. In yet another embodiment, the server device 104 and the database device may be separate bare-metal servers in separate server farms located remotely from each other and networked together via the communication network. In an embodiment, the server application may include multiple instances of the server application installed on a plurality of physical and/or virtual server devices. Similarly, the database application may include multiple instances of the database application installed on a plurality of physical and/or virtual server devices.

Various embodiments of the travel booking system described herein may be referred to in terms of a client-server and/or client-server-database architecture. However, in various embodiments, the elements of the travel booking system may be implemented in other architectures. In various other embodiments, the elements of the travel booking system may be implemented in a combination of two or more architecture types. The architectures of the travel booking system may include a client-server architecture, a client-server-database architecture, a layered architecture, a master-slave architecture, a pipe-filter architecture, a client-broker-server architecture, a peer-to-peer architecture, an event-bus architecture, a model-view-controller architecture, a blackboard architecture, and so forth. For example, the architecture of the travel booking system may include a client-server-database architecture combined with a master-slave architecture. The server may include a master server and may distribute client calls to multiple slave servers. The travel booking system may include other combinations of system architectures or individual system architectures.

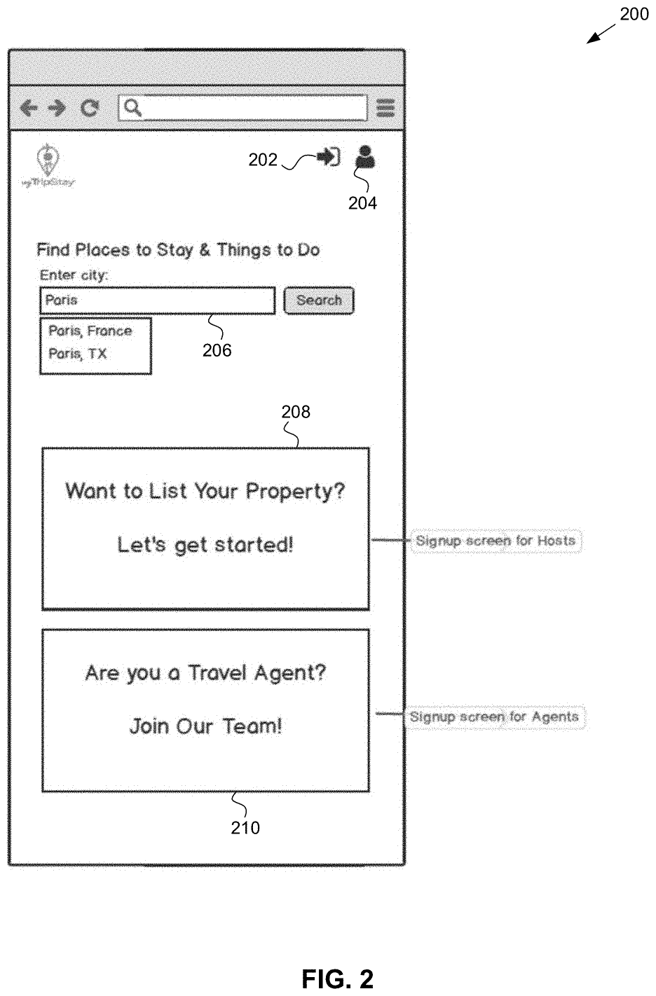

FIG. 2 illustrates a landing page 200 of a travel booking system, according to an embodiment. The landing page 200 may include a login link 202, a profile link 204, a travel search bar 206, a host signup link 208, and a travel agent signup link 210. In general, the links on the landing page 200 may direct a user of the travel booking system to another page. For example, clicking on a link may send a call for a page and/or information associated with the link. Clicking on the link may cause a new page to be loaded with the information associated with the link.

Various pages depicted in the figures may represent UI elements of a client application. For the sake of clarity and brevity, application logic, data structures, and/or various UI elements of the client application, the server application, and/or the database application may be described in the context of the pages depicted in the figures. Furthermore, the various pages depicted in the figures may represent a web client application, but the various elements and/or features described regarding the various pages may be understood to apply to a mobile client application, a desktop client application, and so forth. Accordingly, whereas a page described herein may be referred to in terms of a web client application, it may be understood that the features described regarding the page may be embodied in application logic and/or UI design elements for a mobile client application, a desktop client application, and so forth.

In an embodiment, the database application may store information associated with the travel booking system. The information may include public information such as short-term rental property listings, hotel listings, for sale property listings, property wanted listings, travel agent listings, excursion listings, airfare listings, car rental listings, cruise listings, and so forth. The public information may be accessible by any user with or without a profile. In an embodiment, the database application may store private information associated with a specific user profile and/or a specific type of user. The private information may include payment methods, a travel itinerary, a client list, a host's property listings available for rent, a host's property listings available for sale, lists of users that have purchased an excursion from an excursion offeror, and so forth. The client application may retrieve the public information via a public session generated by the server application. The client application may retrieve private information the user has authorization to view via a private session authenticated by the server application. The server application may authenticate the user using login credentials such as a username and/or password sent to the server application from the client application.

The landing page 200 may include elements that may allow a user to access the private information. For example, the login link 202 may link to a login page. On the login page, the user may enter the user's login credentials. The login credentials may be sent from the client application to the server application. The server application may generate an authenticated private session based on the login credentials. In the private session, the user may access private information associated in the database with the user. For example, during a private session, selecting the profile link 204 may direct the client application to a profile page. The server application may retrieve profile information associated with the user and may transmit the profile information to the client application. The client application may load the profile page with the profile information received from the server application. In an embodiment, selecting the profile link 204 during a public session may direct the user to the login page. In another embodiment, selecting the profile link 204 during a public session may direct the user to a Signup page where the user can create login credentials.

The user may use the travel search bar 206 to generate a database query. The client application may transmit the query to the server application. If the server application is running a public session associated with the client application, the server application may retrieve public information associated with the query and transmit the public information to the client application. If the server application is running a private session associated with the client application, the server application may retrieve private and/or public information associated with the query and transmit the private and/or public information to the client application. For example, an unregistered user may query the database during a public session for listings associated with “Paris.” The server application may retrieve listings associated with Paris, France and with Paris, Tex. In another example, a registered user may query the database during a private session for listings associated with “Paris.” The server application may search the database application for listings associated with “Paris” and with the user and may determine the user has a current itinerary for Paris, France. The server application may retrieve the Paris, France itinerary and transmit the itinerary to the client application, which may display the itinerary to the user.

The landing page 200 may include elements that may prompt an unregistered user to register. The elements may correspond to different types of users. For example, the host signup link 208 may prompt a user interested in listing a property in the travel booking system to click on the host signup link 208. Selecting the host signup link 208 may direct the user to a registration page tailored for travel hosts. In another example, the travel agent signup link 210 may prompt a user interested in being listed as a travel agent in the travel booking system to click on the travel agent signup link 210. Selecting the travel agent signup link 210 may direct the user to a registration page tailored for travel agents.

In an embodiment, the server application may include application logic for creating user accounts for different types of users. The server application may also include application logic for allowing an unregistered user to browse information indicated as public in the database application. The different types of users may include a consumer user, an agent user, a host user, and/or an administrator user. The server application logic may make public information available to any type of user. The server application logic may make private information available to a specific type of user and/or a specific user. For example, an agent user may be able to see commissions payable for any listing. In another example, a specific agent user may be able to view travel itineraries of the agent's clients, but not travel itineraries of another agent's clients.

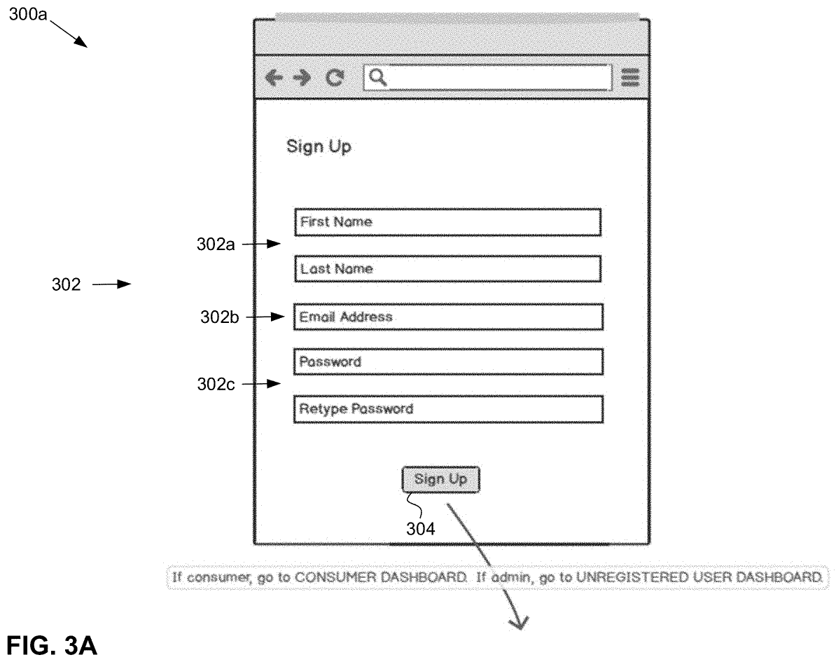

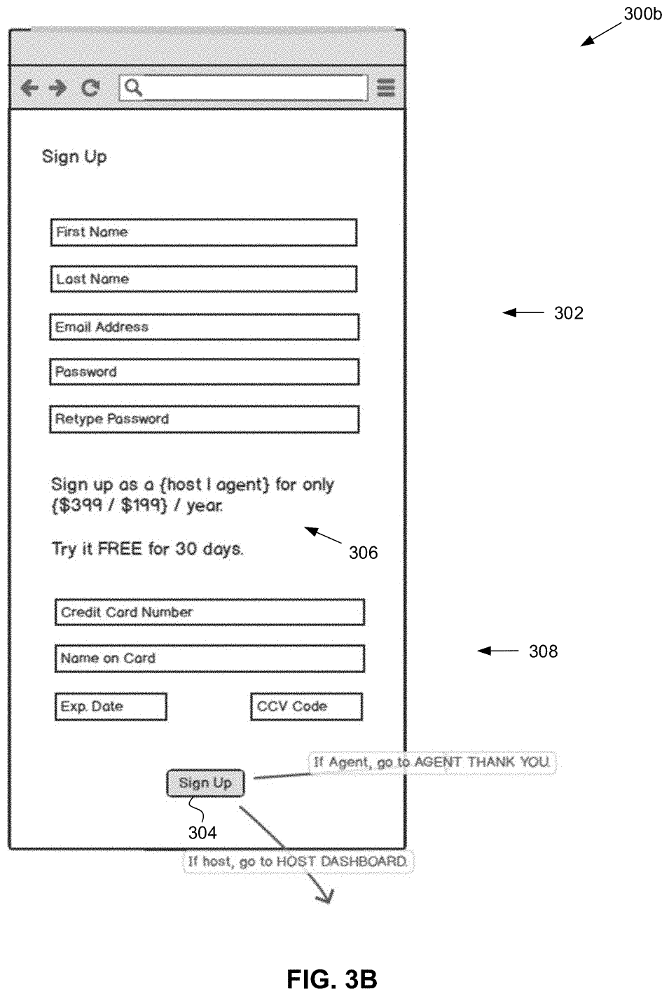

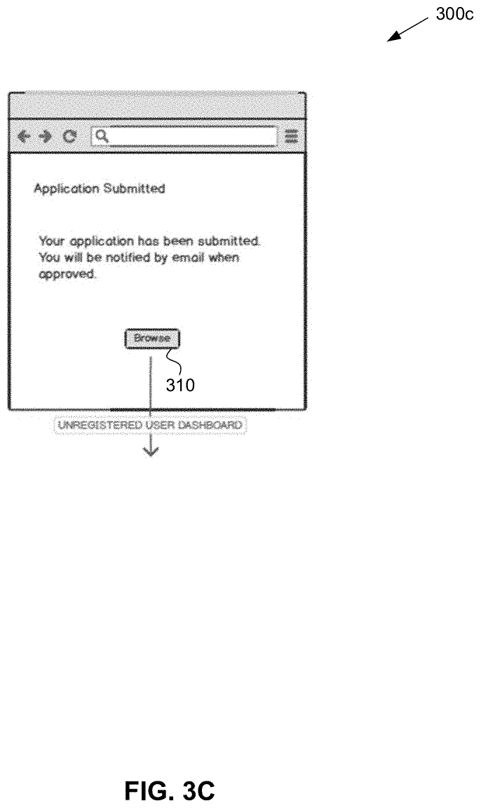

FIG. 3A illustrates a consumer registration page 300a of the travel booking system, according to an embodiment. The consumer registration page 300a may include user information input boxes 302 and a submit link 304. The user information input boxes 302 may include name input boxes 302a, an email address input box 302b, and/or password boxes 302c. Selecting the submit link 304 may transmit the information in the user information input boxes 302 from the client application to the server application. The server application may include application logic that adds the user information to a consumer account table in the database application. The consumer account table may include information specific to a consumer such as past trips, future trips, trip itineraries, favorited listings, payment method information, and so forth.

FIG. 3B illustrates a host/agent registration page 300b of the travel booking system, according to an embodiment. Similar to the consumer registration page, the host/agent registration page 300b may include the user information input boxes 302 and the submit link 304. The host/agent registration page 300b may additionally include pricing information 306 and payment information input boxes 308. Selecting the submit link 304 from the host/agent registration page 300b may send the information from the user information input boxes 302 and the payment information input boxes from the client application to the server application. In an embodiment, the server application may include application logic that adds the information to a host account table in the database application or an agent account table in the database application. The host account table may include information specific to a host account, such as property listings for rent by the host user, property listings for sale by the host user, availability of property listings for rent by the host user, pricing information for the host user's listings, bookings of the host user's listings, and so forth. The agent account table may include information specific to an agent account, such as consumers associated with the agent user, trip itineraries of consumers associated with the agent user, listings favorited by the agent user, commissions earned by the agent user, and so forth.

FIG. 3C illustrates a post-registration landing page 300c for an agent user and/or an administrator user, according to an embodiment. In an embodiment, registration of a new agent user account and/or a new administrator user account may prompt a current administrator user to approve the new agent user account or the new administrator user account. When a user seeking to obtain an agent user account selects the submit link 304, the client application may transmit the agent user information to the server application. The server application may add the agent user information to the agent account table. The server application may redirect the user to the post-registration landing page 300c. The server application may generate a prompt designated for a current administrator user. The prompt may request the current administrator user approve the new agent user account or the new administrator user account. The current administrator user may receive the prompt at an instance of the client application running on a client device operated by the current administrator. In an embodiment, the server application may generate a push notification and transmit the push notification to the current administrator user's instance of the client application. In an embodiment, the post-registration landing page 300c may include a redirect link 310. Selecting the redirect link 310 may cause the client application to load an unregistered user dashboard page.

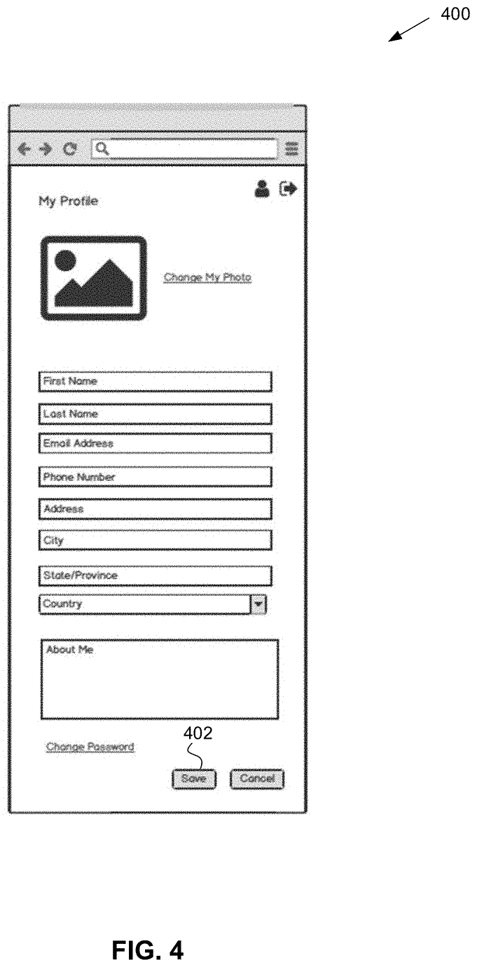

FIG. 4 illustrates a profile page 400 of a travel booking system, according to an embodiment. In an embodiment, during a private session clicking on the profile link 204 may load the profile page 400 in the client application. In an embodiment, the user may edit information about the user on the profile page 400. Selecting the save link 402 may send the edited information to the server application. The server application may include application logic to update the database application with the edited information.

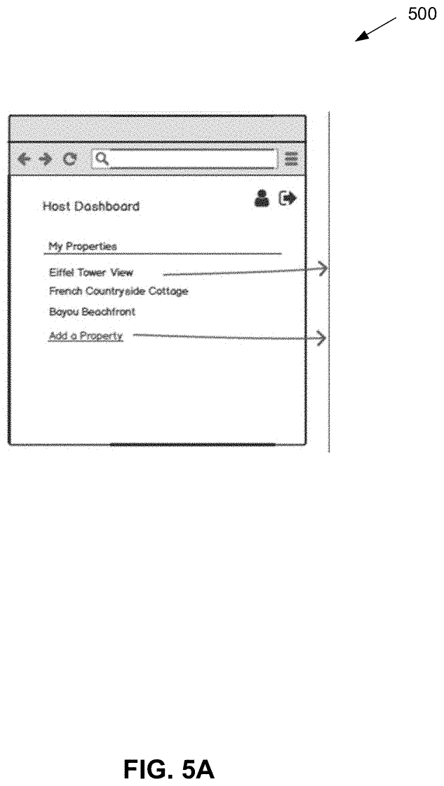

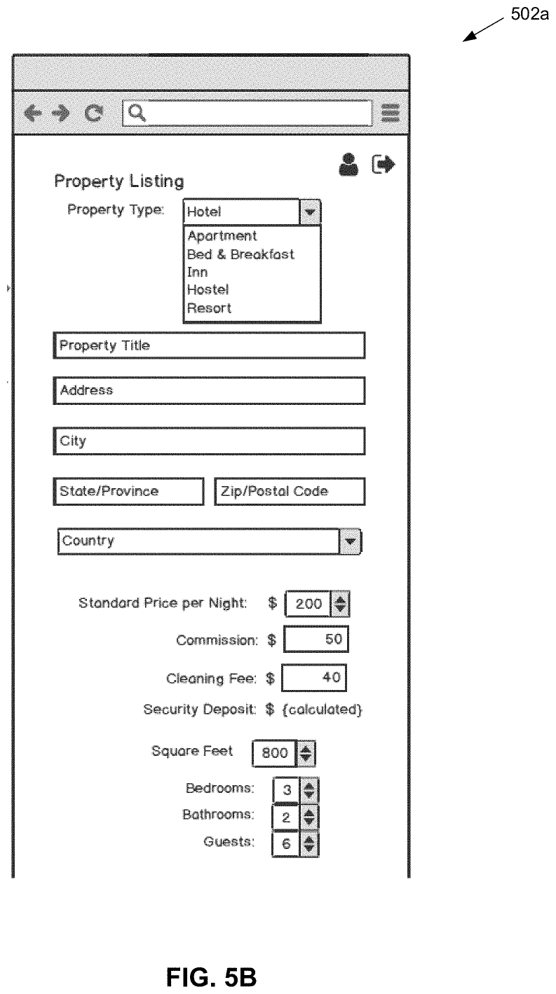

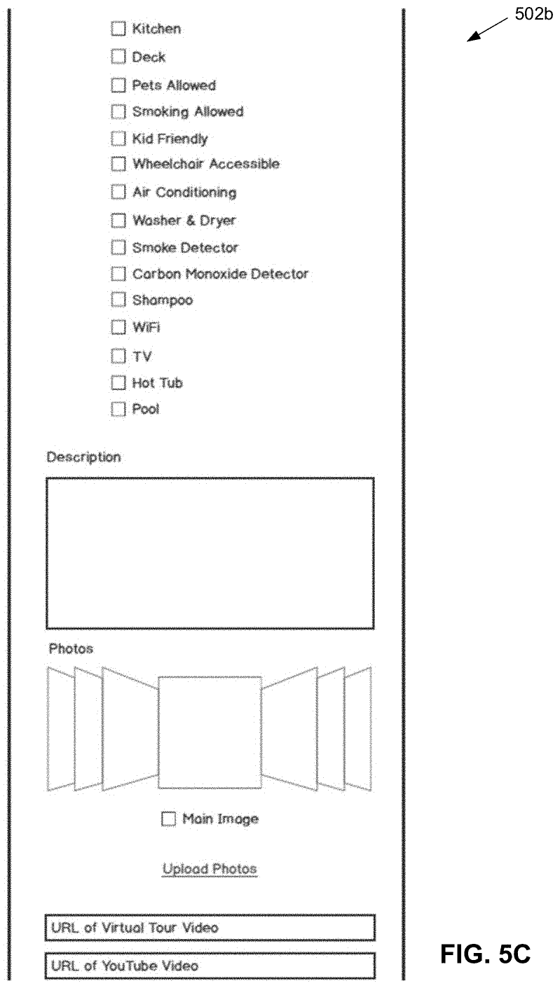

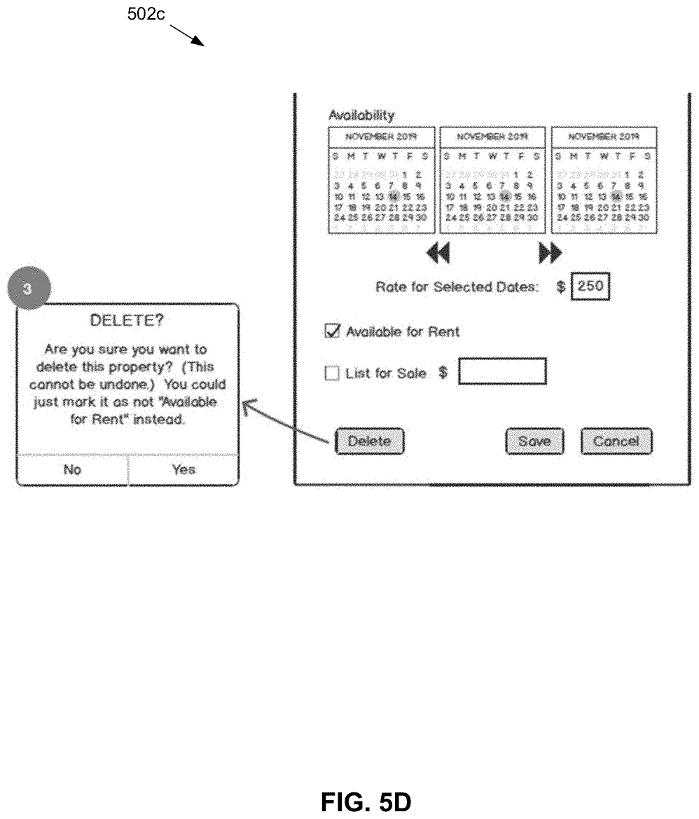

FIG. 5A illustrates a host dashboard 500, according to an embodiment. The host dashboard 500 may be accessible in a private session associated with a host user account. The host dashboard 500 may include a list of properties owned by the host and listed in the travel booking system.

In an embodiment, the server application may include application logic which may enable a host user to list a property for sale that is associated with an account of the host user. Listing the property for sale may automatically generate information, such as a frequency of which the property is booked, historically how much revenue has been generated by the property for the host, upkeep costs of the property, and/or other information which may allow a potential buyer of the property to evaluate the property from an investment perspective. The application logic may include options for the host user to select what information about the property is viewable in the travel booking system. For example, the host user may select an annual revenue of the property as being viewable but not booking frequency. In another example, the application logic may include generating a prompt for a potential buyer to contact the host user for information about the property relevant to an investment in the property.

FIG. 5B illustrates a first section 502a of a property listing view available to a host user in the travel booking system, according to an embodiment. In an embodiment, during a private session, a host user may view and/or edit information about a listing associated with the host user account. The information may include pricing information for the listing, including a nightly fee, a cleaning fee, and a commission payable to an agent user that books the listing on behalf of a consumer user. The cleaning fee may be added to the nightly fee. In an embodiment, the commission may not be added to the nightly fee and/or the cleaning fee. Rather, the commission may reflect an amount deducted from a total amount payable to the host user for a booking.

FIG. 5C illustrates a second section 502b of a property listing view available to a host user in the travel booking system, according to an embodiment. In an embodiment, during a private session, the host user may view and/or edit amenity information about the listing, pictures of the property associated with the listing, a custom description by the host user of the listing, a virtual tour of the property associated with the listing, and/or a video associated with the listing. The information about the listing may be stored in the database application and retrieved by the server application based on a request by the client application.

FIG. 5D illustrates a third section 502c of a property listing view available to a host user in the travel booking system, according to an embodiment. In an embodiment, during a private session, the host user may view and/or edit availability information about the listing and/or specific rate information for a particular date. The host user may select whether to list the property associated with the listing for rent. The host user may select whether to list the property associated with the listing for sale. The host user may select whether to delete the listing. Actions performed in the property listing view by the host user during a private session may be transmitted to the server application. The server application may update the database application based on the actions by the host user in the client application.

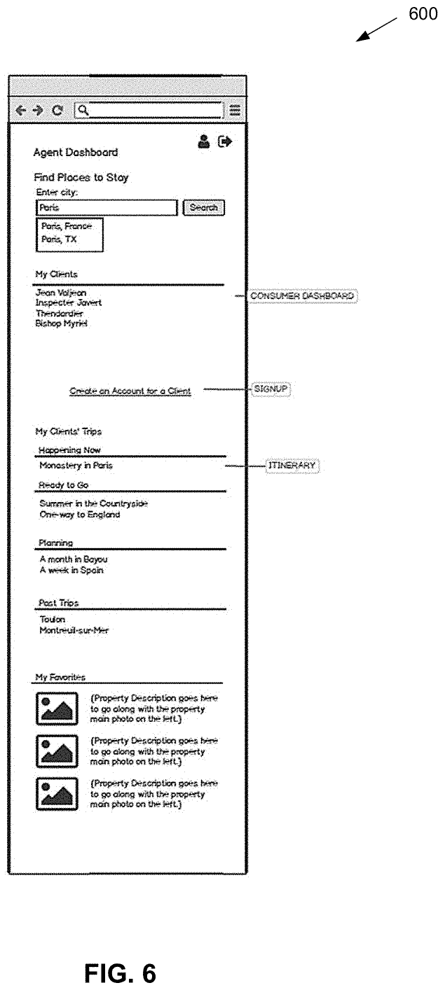

FIG. 6 illustrates an agent dashboard 600, according to an embodiment. The agent dashboard 600 may be viewable by an agent user in a private session on the server application. The agent dashboard 600 may include a search bar, a list of clients of the agent, a list of trips and/or itineraries of clients of the agent, and a list of listings in the travel booking system favorited by the agent.

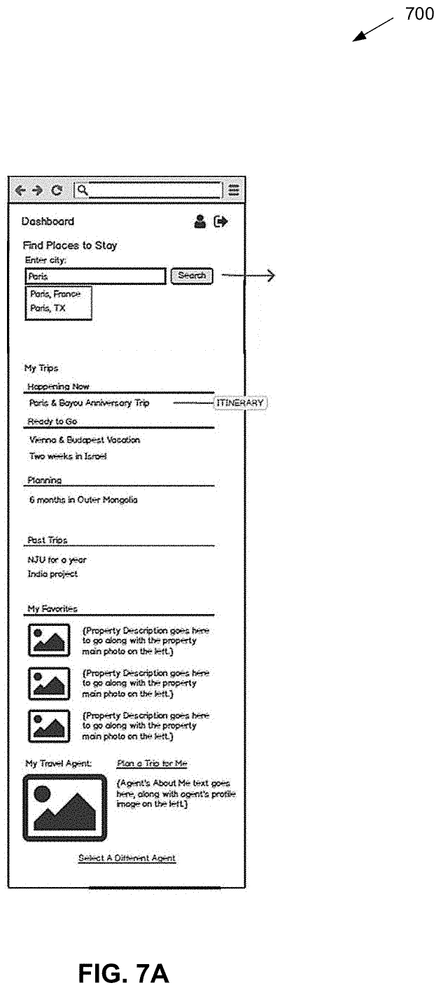

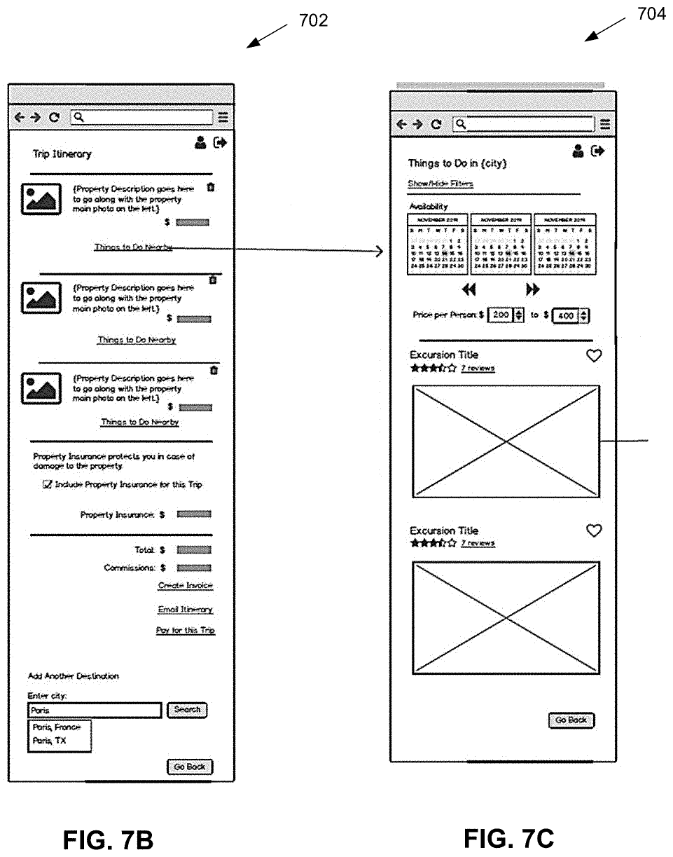

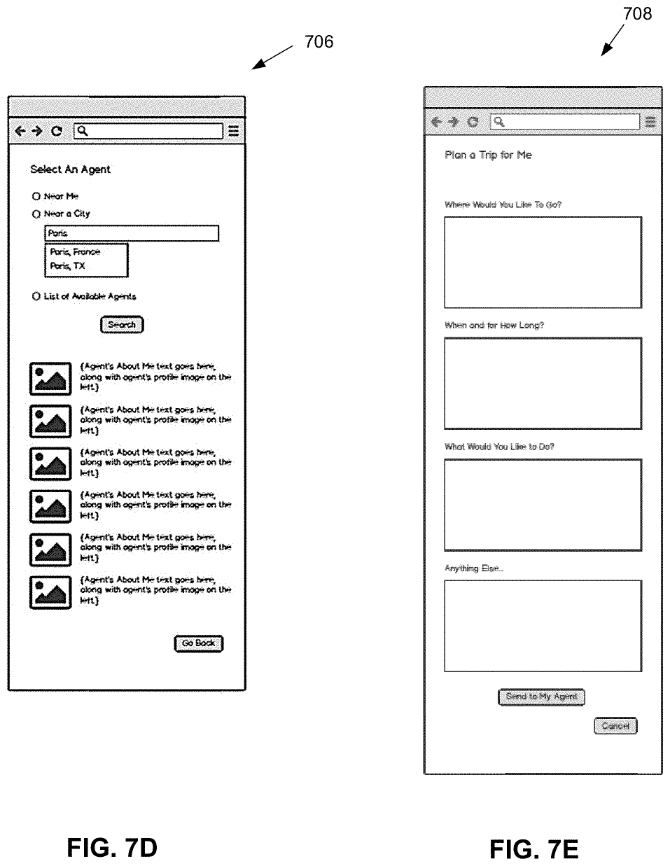

FIG. 7A illustrates a consumer dashboard 700 of the travel booking system, according to an embodiment. The consumer dashboard may include a travel search bar, a list of current, past, and/or future trips, a list of listings favorited by the consumer, and/or a link to a profile page of a travel agent associated with the consumer user account.

FIG. 7B illustrates a trip itinerary page 702 of the travel booking system, according to an embodiment. The trip itinerary page 702 may be available in a private session to a consumer user, including trip information specifically associated with the consumer user account. The trip itinerary page 702 may be available in a private session to an agent user, including trip information associated with a consumer user account associated with the agent user account. The trip itinerary page 702 may include a list of locations and/or bookings for a trip. The trip itinerary page 702 may include a cost of the bookings for the trip and a total cost for the trip. The trip itinerary page may include a travel search bar which may allow the user to search for other travel listings. The trip itinerary page may include links to excursion listings near a location and/or booking associated with the itinerary.

FIG. 7C illustrates an excursion listings page 704 of the travel booking system, according to an embodiment. The excursion listings page 704 may include a calendar where the user may select dates for an excursion, a price tool for the user may select a price range for excursions, and a list of results corresponding to the filters the user applies. The excursion listings page 704 may be specific to a particular location, such as a location where a consumer or agent may be planning a trip. The excursion listings page 704 may include results corresponding to multiple locations. The multiple locations may be locations associated with the user's travel itinerary. In an embodiment, the excursion listings page 704 may be viewable in a public session and/or in a private session. In the public session, the excursion listings page 704 may include excursions associated with a search performed by the user in the public session. In the private session, the excursion listings page 704 may be tailored to the user, such as by including excursions associated with locations in the user's travel itinerary, and so forth.

FIG. 7D illustrates an agent listings page 706 of the travel booking system, according to an embodiment. The agent listings page 706 may include an agent filter section which may allow the user to filter and/or search for agents in a particular location or agents available for hire. The agent listings page 706 may include a list of agents corresponding to the filters selected by the user and/or a complete list of agents associated with the travel booking system. The agent listings page 706 may be viewable in a public session and/or a private session. In a public session, the user may view and/or filter agents. In a private session, the user may select an agent to hire.

FIG. 7E illustrates an agent request form 708 of the travel booking system, according to an embodiment. The agent request form 708 may include form boxes that may allow the user to describe a trip the user would like the agent to plan. The agent request form 708 may include a submit link. In an embodiment, selecting the submit link may cause the client application to send the form information to the server application. The server application may determine a consumer user account associated with the form information and an agent user account associated with the consumer user account. In one embodiment, the server application may push the form information to an instance of the client application associated with the agent user account. In another embodiment, the server application may cause the form information to be stored in the database application and may push a notification to the instance of the client application associated with the agent user account notifying the agent the form information has been submitted by the consumer.

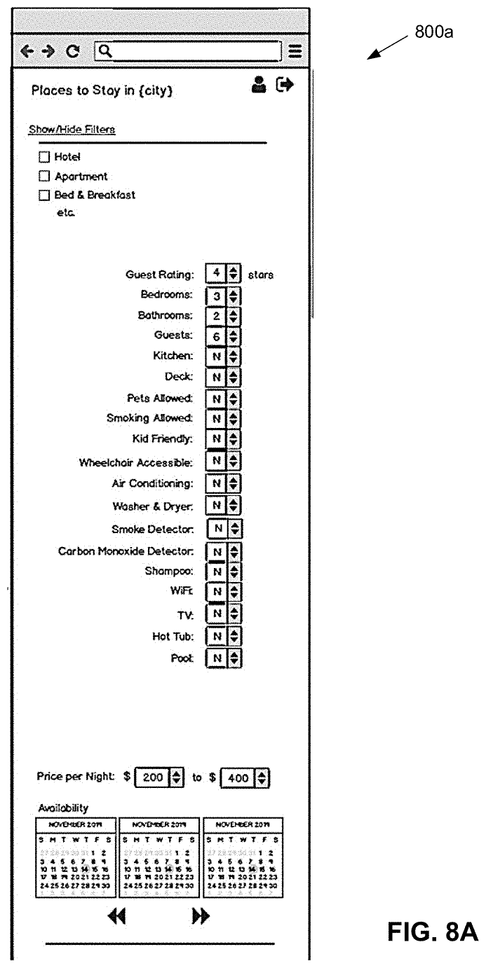

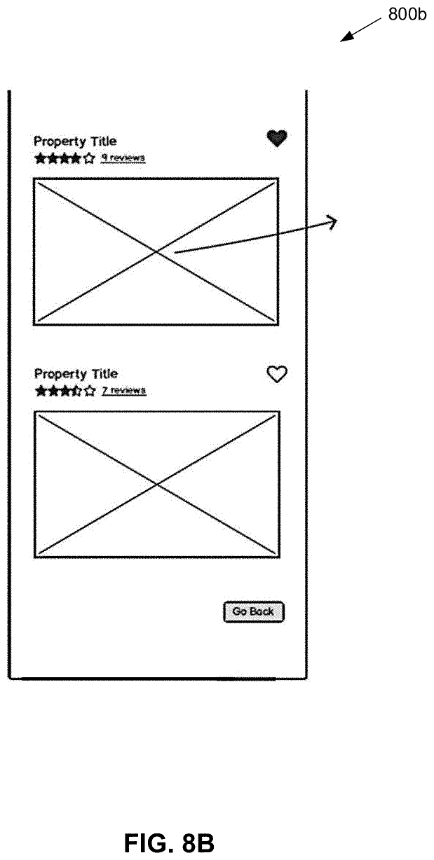

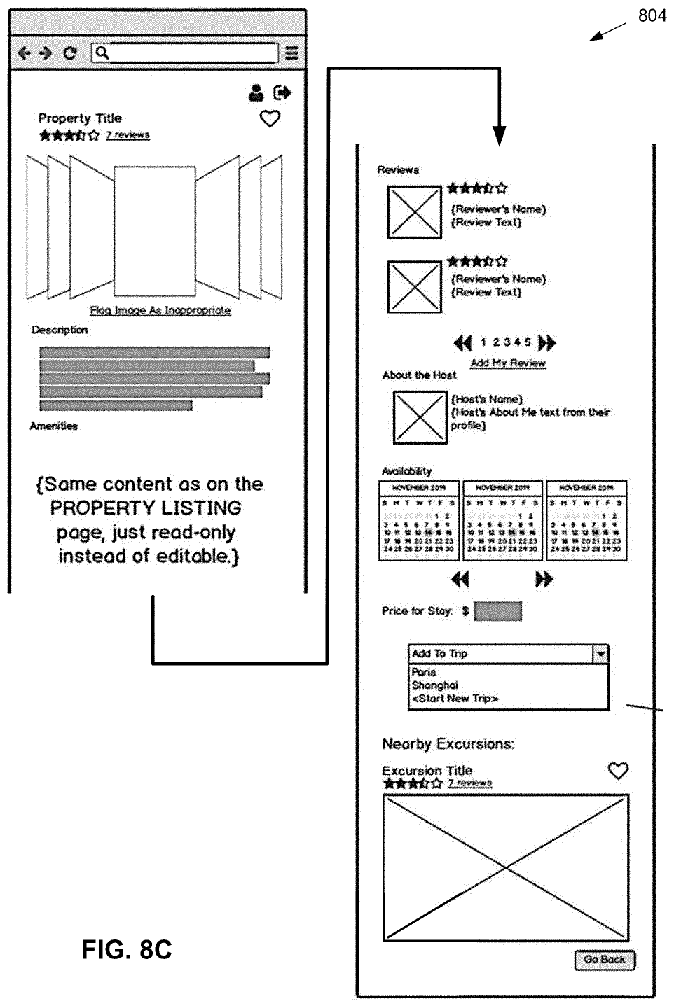

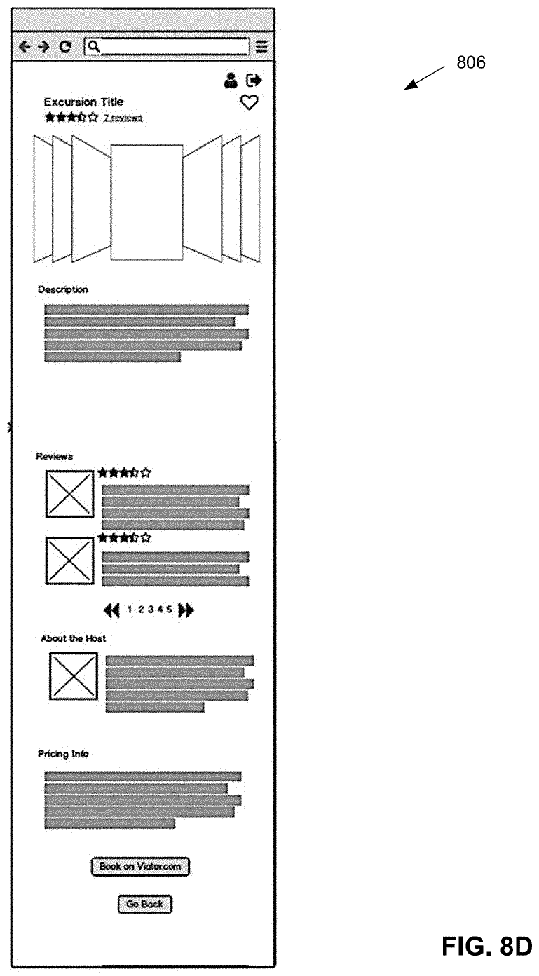

FIG. 8A illustrates a first section 800a of a property listing search page of the travel booking system, according to an embodiment. Additionally, reference may be made to features shown in any of FIGS. 1-7E and not shown in FIG. 8A. The first section 800a of the property listings search page may include search filters such as property features and/or amenities, a price filter, and/or a date filter.

FIG. 8B illustrates a second section 800b of the property listings search page of the travel booking system, according to an embodiment. The second section 800b of the property listings search page may include links to property listings, ratings for the property listings, and/or exemplary or main photos of the properties associated with the property listings. In a private session view, the second section 800b of the property listing search page may include favorites links which may allow a consumer user to favorite a property listing. Favoriting the property listing may associate the property listing with the consumer user account.

FIG. 8C illustrates a property listing page 804 of the travel booking system, according to an embodiment. The property listing page 804 may include images of the property associated with the property listing, information about features and/or elements of the property associated with the property listing, reviews of the property and/or host associated with the property listing, and/or a list of excursions associated with the property listing and/or near the property. In an embodiment, during a private session, the property listing page 804 may also include booking information such as availability, pricing, and/or the ability to add the property listing to a travel itinerary associated with the user.

FIG. 8D illustrates an excursion information page 806 of the travel booking system, according to an embodiment. The excursion information page 806 may include pictures associated with the excursion listing, a rating of the excursion, a description of the excursion, reviews of the excursion, pricing information, information about the host of the excursion, and/or a link to book the excursion. In an embodiment, the link to book the excursion may be available in a public session and/or may link to a page outside the travel booking system. In another embodiment, the link to book the excursion may be available in a private session and may be associated with application logic in the server application. The server application may send booking information associated with the excursion to the instance of the client application in which the booking link was selected.

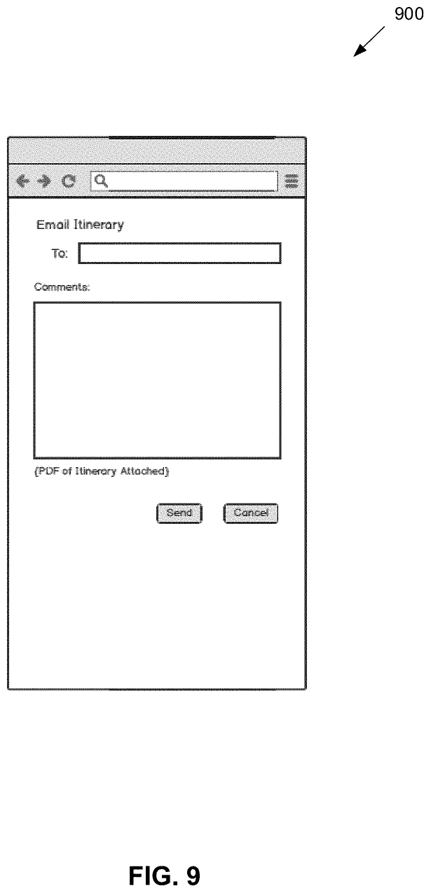

FIG. 9 illustrates a share page 900 for sharing a travel itinerary in the travel booking system, according to an embodiment. The share page 900 may allow the user to generate a message. The message may include information taken from the travel booking system such as a user's travel itinerary, a property listing, an excursion listing, a property listed for sale, and so forth. The message may be sent within the travel booking system from one user of the travel booking system to another user of the travel booking system. The message may be sent outside the travel booking system such as to an email address. The message may direct the recipient of the message to a page in the travel booking system. The message may include a document such as a portable document format (PDF) with the information designated for the recipient. In one embodiment, the message may include a PDF of a travel itinerary. The share page 900 may be available in a public session. The user in the public session may send information about a listing to an address such as an email address outside the travel booking system. The share page 900 may be available in a private session. The user in the private session may send information to another user in the travel booking system. For example, a travel agent may send an itinerary to a consumer in the travel booking system, or to an email address of the consumer.

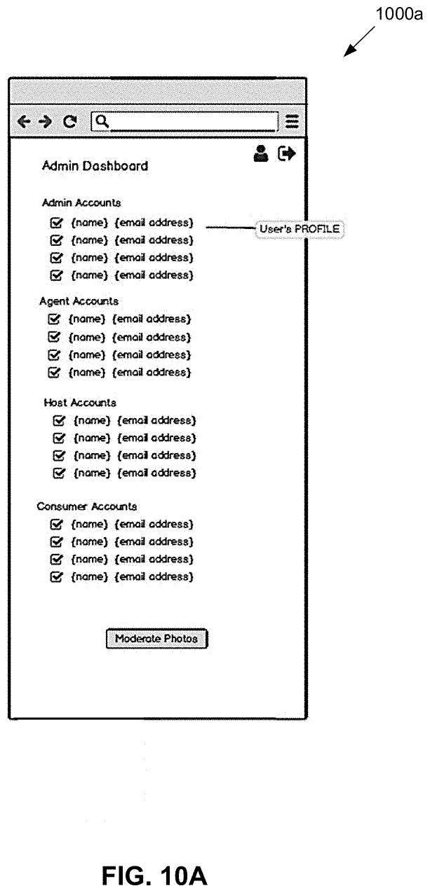

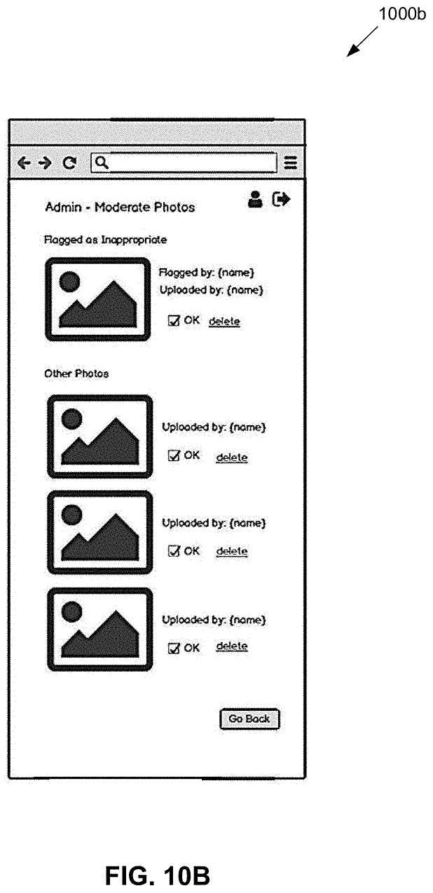

FIG. 10A illustrates a first page 1000a of an administrator dashboard of the travel booking system, according to an embodiment. The first page 1000a of the administrator dashboard may include a list of accounts and/or a link to moderate listings in the travel booking system. The list of accounts may be organized according to account type, i.e., administrator accounts, agent accounts, host accounts, consumer accounts, and so forth. The first page 1000a of the administrator dashboard may be viewable in a private session associated with an administrator user account. The first page 1000a of the administrator dashboard may allow an administrator user to activate, deactivate, and/or approve other user accounts.

FIG. 10B illustrates a second page 1000b of the administrator dashboard of the travel booking system, according to an embodiment. The second page 1000b of the administrator dashboard may include a list of listings on the travel booking system, a list of photos in the travel booking system, a list of user accounts associated with the listings or photos, and/or a link for an administrator user to approve, disapprove, activate, and/or deactivate a listing and/or photo in the travel booking system. An approved and/or activated listing and/or photo may be visible in the travel booking system to users of the travel booking system. A disapproved and/or deactivated listing and/or photo may not be visible in the travel booking system. The second page 1000b of the administrator dashboard may be viewed in a private session associated with an administrator user account.

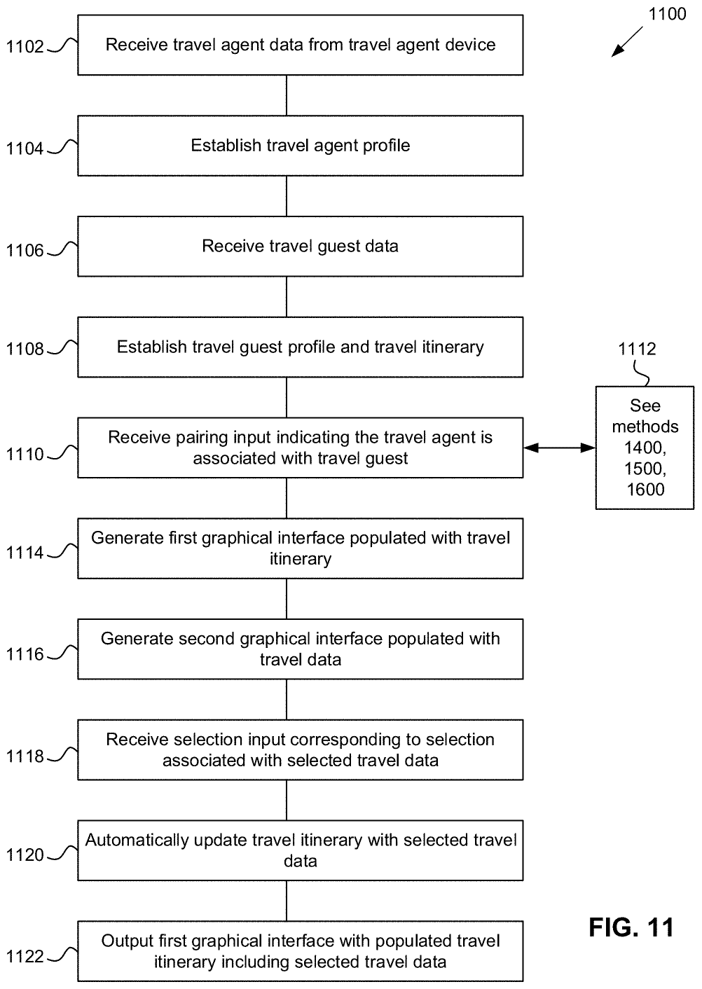

FIGS. 11-22 illustrate various methods associated with the travel booking system. The methods may be embodied as executable code stored on a memory device and executable by a processing device. The memory device may, for example, be memory associated with the cloud-based network 110, such as in the database device 106. The memory device may be a distributed memory device, i.e., memory distributed across two or more hardware devices that are networked together. The processing device may, for example, be processing capability associated with the cloud-based network 110, such as in the server device 104. The processing device may be a distributed processing device, i.e., processing capability distributed across two or more hardware devices that are networked together. The methods described below may be executed as part of a single system, e.g., the travel booking system. User interfaces of the travel booking system may have the same look and feel for various users and various different pages.

FIG. 11 illustrates a method 1100, executable by a processing device, of generating graphical interfaces for travel agents and travel guests in the travel booking system and pairing a travel guest and travel agent, according to an embodiment. The travel booking system may allow travel agents and travel guests to search and book travel in the same system and environment. It may also allow travel agents to directly see the benefit of using a travel agent, where the travel agent can leverage volume pricing and other discounts to save the travel guest money on their vacation bookings. The travel booking system may enable travel guests to be paired with travel agents based on various preferences of the travel guests or by browsing travel agent profiles. Travel agents may also be able to view travel guest profiles to promote their services and demonstrate to travel guests how the travel agent can save the travel guest money.

The method 1100 may include receiving, from a travel agent device, travel agent data that corresponds to information about a travel agent (block 1102). The information may include demographic information about the travel agent, licensing information about the travel agent, a name of an agency the travel agent works for, and so forth. The information may include an area of specialty of the travel agent such as a particular type of travel (e.g., cruises, cross-country trips, historical trips, and so forth) and/or a particular region (e.g., South America, Europe, Asia, Mediterranean, Caribbean, and so forth). The method 1100 may include establishing, based on the travel agent data, a travel agent profile (block 1104). The travel agent data in the travel agent profile may be searchable and/or may be used to promote the travel agent's services in the travel booking system. The information in the travel agent profile may also be used in the travel booking system to book travel and/or a vacation for the travel agent.

The method 1100 may include receiving, from a travel guest device, travel guest data that corresponds to information about a travel guest (block 1106). A travel guest may include an individual seeking to book travel and/or a vacation for themselves and/or a group of which they are a part. The travel guest data may include demographic information about the travel guest. The travel guest data may include past trips taken by the travel guest. The travel guest data may include desired travel dates, locations, types of desired travel, budgets, and so forth. The method 1100 may include establishing, based on the travel guest data, a travel guest profile, and a travel itinerary (block 1108).

The travel guest profile may include a travel preference of a user associated with the travel guest profile (e.g., the travel guest). The travel guest profile may be searchable by travel agents to enable travel agents to offer booking services for the travel guest. The travel data displayed at the travel agent device via a graphical interface and in association with a travel agent profile may be filtered according to the travel preferences of the travel guests (e.g., a particular travel agent may only be shown travel guest profiles for travel guests interested in cruises, and so forth). The travel guest profile may be automatically searchable by the travel booking system to recommend travel, accommodations, excursions, a particular travel agent and/or agency, and so forth.

The travel itinerary may initially be an empty data set. The travel itinerary may be a data structure with variables such as date data, transportation data, lodging data, excursion data, dining data, shopping data, and so forth. The travel itinerary may include variables such as proposed travel items and/or accepted travel items. The travel itinerary may include a hierarchy of preferred travel items with back-up travel items in case a booked travel item falls through.

The method 1100 may include receiving, from the travel agent device or the travel guest device, a pairing input indicating a particular travel agent is associated with a particular travel guest (block 1110). The pairing input may be received upon execution, for example, of one or more methods described herein below (block 1112). In general, pairing instructions may be executable by a processing device to: automatically pair the travel guest profile with the travel agent profile based on a key indicator; enable browsing, at the travel guest device and/or at the travel agent device, of a plurality of travel agent profiles and/or a plurality of travel guest profiles; and/or enable filtered searching, at the travel guest device and/or at the travel agent device, of the plurality of travel agent profiles and/or the plurality of travel guest profiles.

The pairing input may be received via a graphical interface generated to display, at the travel guest device and/or at the travel agent device, a set of links. The set of links may include a link that, when selected, triggers execution of a set of instructions for automatically pairing a travel guest profile with an individual travel agent profile. The set of links may include a link that, when selected, triggers execution of a set of instructions for presenting, in a graphical interface, a travel agent data set corresponding to a plurality of travel agent profiles (e.g., a graphical interface for browsing travel agent profiles). The set of links may include a link that, when selected, triggers execution of a set of instructions for searching a travel agent database based on a search filter. The pairing input may correspond to selection of one of the links (e.g., the automatic pairing link, the browsing link, and/or the searching link).

In response to receiving the pairing input, the travel agent profile may be updated to indicate the travel agent represents the travel guest in booking travel generally for the travel guest or in booking travel for a specified event (e.g., a particular vacation) for the travel guest. Similarly, in response to receiving the pairing input, the travel guest profile may be updated to indicate the travel agent represents the travel guest. The travel guest may be enabled, via a graphical interface of the travel booking system, to view the travel agent profile. The travel agent may similarly be enabled, via a similar graphical interface, to view the travel guest profile.

The method 1100 may include generating, for display at the travel agent device and/or at the travel guest device, a graphical interface populated with the travel itinerary (block 1114). The graphical interface for the travel itinerary may include a proposed item indicator and an accepted item indicator. An itinerary item may be proposed by the travel agent via a user device running an instance of the client application of the travel booking system. An itinerary item may be proposed by the travel guest via a user device running another instance of the client application of the travel booking system. The client application may include instructions for generating the graphical interface at the user device. The instructions may be specified differently for different profile types. For example, the graphical interface may allow proposing items and accepting items when operating under permissions associated with the travel guest profile. The graphical interface may allow proposing items and may only display an accepted and/or unaccepted status for the proposed items when operating under permissions associated with the travel agent profile.

The method 1100 may include generating, for display at the travel agent device and/or at the travel guest device, another graphical interface populated with travel data (block 1116). The travel data may include date data that corresponds to a travel date. For example, the travel data may include calendar data with time data, day data, month data, and year data. The travel data may include availability data that corresponds to an availability of a travel element for a particular date. For example, the availability data may include a variable that indicates whether transportation, lodging, dining, excursions, and so forth are available or booked for a particular date.

The travel data may include transportation data that corresponds to travel transportation such as air travel, rail travel, bus travel, boat travel, and so forth. The travel data may include destination data that corresponds to a travel destination such as a city, a state, a country, a region, a particular area within a city, and so forth. The travel data may include lodging data that corresponds to travel lodging such as vacation rentals, hotels, motels, bed and breakfasts, hostels, cabins on cruise ships, and so forth. The travel data may include excursion data that corresponds to a travel excursion such as horseback riding, an all-terrain vehicle tour, a historical tour, a fishing tour, snorkeling lessons, a zoo trip, and so forth. The travel data may include dining data that corresponds to particular locations and/or reservations for dining.

The lodging data may include information about renting a specific lodging short-term. The lodging may be a home, townhome, apartment, villa, and/or cabin owned by a private individual as opposed to a corporate entity. The lodging may be owned by a corporate entity and may be rented out as a vacation rental for specified periods of time. The lodging data may be tied to particular date data and/or particular availability data. The lodging data may include information about purchasing the specific lodging. The information may include a sale price, booking history, tax information, appraisal information, real estate agent contact information, easements, profitability of the rental location, and so forth. The booking system may include a buyer profile for a user interested in purchasing a vacation rental property and a seller profile for a user interested in selling a vacation rental property.

The method 1100 may include receiving, from the travel agent device or the travel guest device, a selection input corresponding to a selection associated with selected travel data (block 1118). The graphical interface displaying the travel data may include a link and/or a variable that enables a user to add a particular travel item to the travel itinerary. The travel itinerary may be stored in a database and read by a server device in generating the graphical interface populated with the travel itinerary. A user may select travel data to add to the travel itinerary by selecting the link in the graphical display of the travel data and/or by updating the variable in the graphical display of the travel data.

The method 1100 may include automatically updating the travel itinerary with the selected travel data (block 1120). For example, the selected travel data may include a vacation rental lodging for a particular set of dates. A location variable of the travel itinerary may be updated to reflect a city and/or region in which the vacation rental lodging resides. A date variable of the travel itinerary may be updated to reflect the particular set of dates. A lodging variable may be updated to reflect the selected vacation rental lodging. The vacation rental lodging may be being offered for sale. A for sale variable of the travel itinerary may be updated to reflect the lodging is being offered for sale. An excursion variable may be updated to reflect one or more excursions offered within a specified (manually or automatically) distance of the lodging. The variable may include a link to a third-party site that directly offers the excursion and/or where the travel guest may book the excursion. A dining options variable of the travel itinerary may be updated automatically to include a list of dining options within a specified (manually or automatically) distance of the lodging. Other variables of the travel itinerary that may be dependent on the lodging variable may be similarly updated, such as a shopping location variable, a points-of-interest variable, and so forth.

The method 1100 may include outputting, to the travel agent device and/or the travel guest device, the graphical interface populated with the travel itinerary (block 1122). The graphical interface may initially be populated with the empty travel itinerary. The graphical interface may be dynamically updated as travel items are selected and added to the travel itinerary. The graphical interface for the travel itinerary may be displayed at the user device side-by-side with the graphical interface for the travel data. As travel data is selected, the travel itinerary may automatically update, and the graphical interface showing the travel itinerary may automatically update so that the user can see the selected travel data populate the travel itinerary as the travel data is selected. The graphical interface for the travel data and the graphical interface for the travel itinerary may be separate graphical containers. In some examples, the graphical containers may be connected functionally so that a user may drag-and-drop travel data from the travel data container to the travel itinerary container.

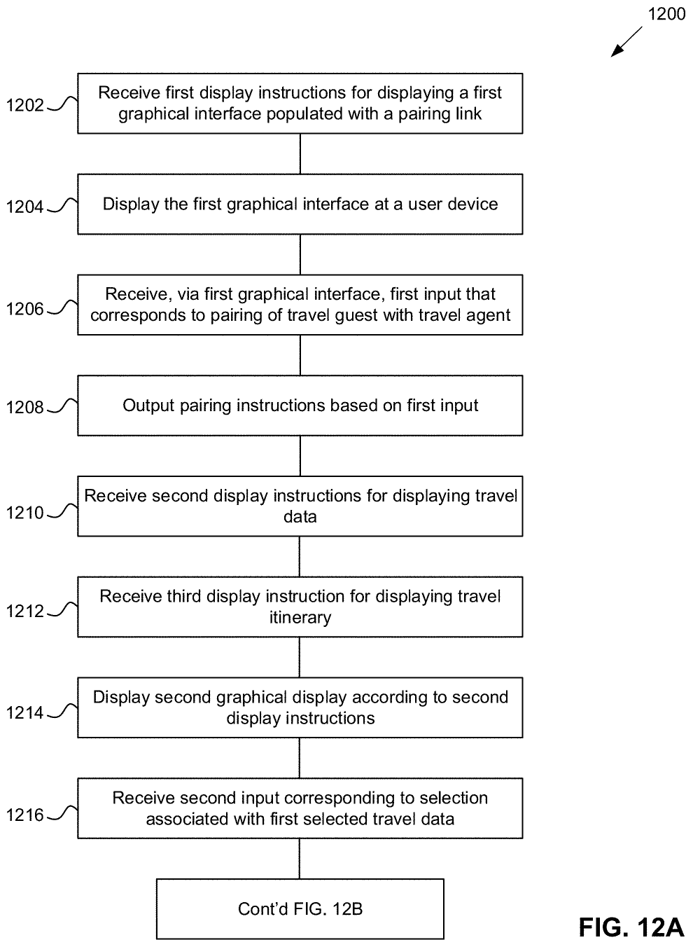

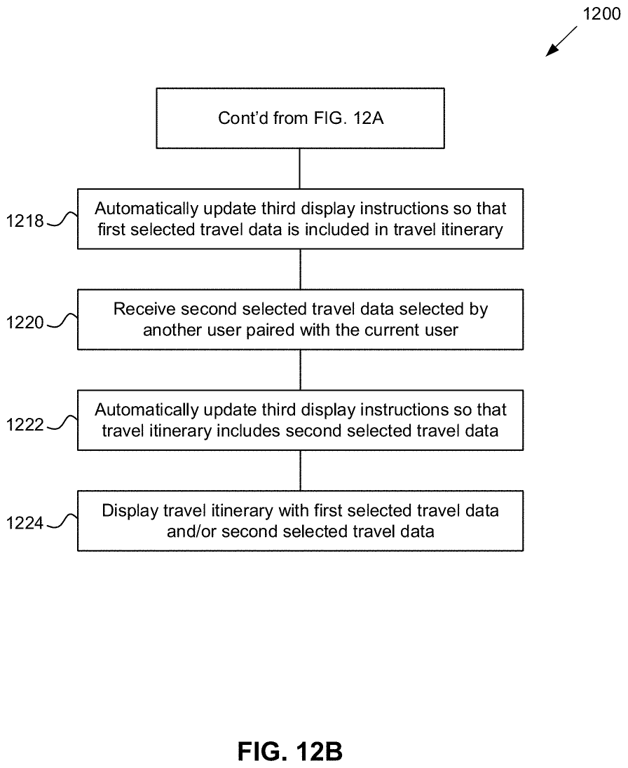

FIGS. 12A-B illustrate a method 1200 for pairing a travel agent profile with a travel guest profile and enabling a travel itinerary displayed via a graphical interface at a user device to be updated from another user device, according to an embodiment. A travel guest may wish to build their own travel itinerary while still utilizing the knowledge and resources of a travel agent. The travel booking system enables the travel guest and the travel agent to collaborate in the same system and with the same data to ensure accuracy of the travel itinerary. The same travel itinerary data may be displayed and manipulated, simultaneously, by the travel agent and the travel guest so that the travel guest's preferences are captured, and the travel agent's resources are fully leveraged (e.g., discounts, bulk pricing, knowledge about prior experiences of travelers, special connections in particular regions, and so forth).

The method 1200 may include receiving, at a user device and from a remote server device (e.g., the server device 104), display instructions for displaying a graphical interface populated with a link that corresponds to pairing instructions (block 1202). The pairing instructions may be executable at the remote server device, upon selection of the link at the user device, for pairing a travel guest profile with a travel agent profile. The method 1200 may include displaying, at the user device (e.g., the travel guest device and/or the travel agent device), the graphical interface with the link that corresponds to the pairing instructions (block 1204). The method 1200 may include receiving, via the graphical interface and at the user device, an input that corresponds to pairing of the travel guest profile with the travel agent profile (block 1206). For example, the input may include selection of the link, which may cause the user device to display another graphical interface associated with a particular pairing method. The method 1200 may include outputting, to the remote server device, the pairing instructions based on the input received via the graphical interface (block 1208).

The method 1200 may include receiving, from the remote server device, display instructions for displaying a graphical interface that is populated using travel data (block 1210). The travel data may be stored at a remote database (e.g., the database device 106) in communication with the remote server device. The method 1200 may include receiving, from the remote server device, display instructions for displaying a graphical interface populated with a travel itinerary associated with the travel guest profile (block 1212). The travel itinerary may be an empty data set. The graphical interface for the travel itinerary may initially show variables, category headings, and so forth, without showing particularly-selected data. For example, the graphical interface may initially show a “Travel Dates” heading next to an empty variable. The method 1200 may include displaying, at the user device, the graphical interface for the travel data according to the received instructions (block 1214).

The method 1200 may include receiving, via the graphical interface for the travel data, an input that corresponds to selection of particular travel data (block 1216). The method 1200 may include automatically updating the instructions for the travel itinerary graphical display so that the selected travel data is included in the travel itinerary (block 1218). The method 1200 may include receiving, from the remote server device, additional selected travel data (block 1220) The additional selected travel data may be selected at another user device by a user paired with the user of the user device displaying the travel data graphical interface and the travel itinerary graphical interface. Similar graphical interfaces may be displayed at the other device and may be based on the same instructions provided from the remote server device.

The method 1200 may include, in response to receiving the additional selected travel data, automatically updating the display instructions for the travel itinerary so that the travel itinerary includes the additional selected travel data (block 1222). The method 1200 may include displaying, at the user device, the travel itinerary graphical display (block 1224). The graphical display may include the travel data selected at the user device and/or the travel data selected at the other user device and received from the remote server.

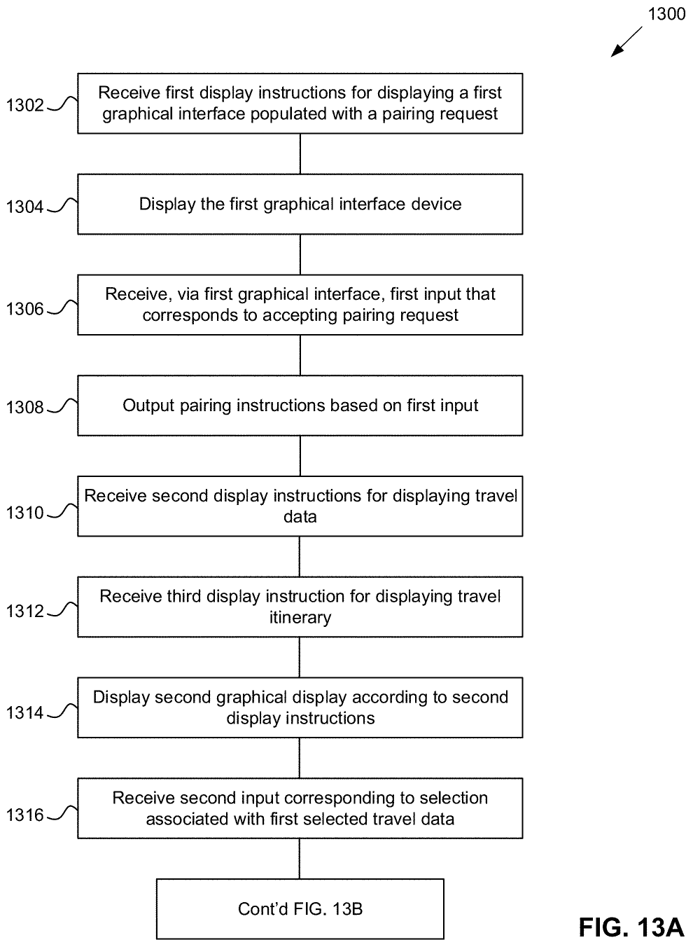

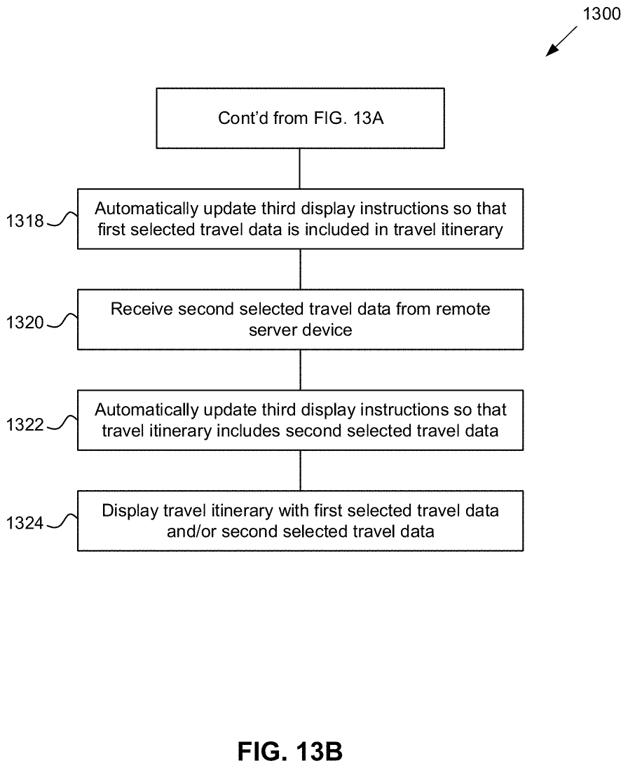

FIGS. 13A-B illustrate a method 1300 of receiving and accepting a pairing request, and subsequently enabling sharing of a common travel itinerary at devices associated with the paired profiles, according to an embodiment. In some cases, a travel agent may identify a particular travel guest whom the travel agent believes they can serve based on the travel agent's unique profile. Similarly, a travel guest may identify a particular travel agent with whom the travel guest wishes to pair because of the travel guest's particular preferences and/or the travel agent's unique profile. In some cases, a travel agent profile may be paired with a travel guest profile, and a subsequent request to pair with either profile may be automatically turned away. However, in other cases, a user may be open to pairing with a different and/or additional user. A user profile may be enabled to manually accept and/or reject pairing requests to allow for changes and/or additions.

The method 1300 may include receiving, at a user device and from a remote server device, display instructions for displaying a graphical interface populated with pairing data (block 1302). The pairing data may correspond to one or more requests by other users of other user devices to pair with the user of the present user device. For example, the user device may be associated with a travel agent profile. The pairing data may include requests associated with one or more travel guest profiles to pair with the travel agent profile. The user device may be associated with a travel guest profile and the pairing data may include requests associated with one or more travel agent profiles to pair with the travel guest profile. The method 1300 may include displaying the graphical interface with the pairing data at the user device (block 1304).

The method 1300 may include receiving, via the graphical interface, an input that corresponds to pairing of the user profile with another user profile (block 1306). The input may be selection of a link and/or variable associated with the other user profile that indicates a request by the other profile to pair is accepted. The method 1300 may include outputting, to the remote server device and from the user device, pairing instructions based on the input (block 1308). The pairing instructions, when executed by the remote server device, may update a travel agent profile and a travel guest profile in a remote database to indicate the two profiles are paired.

The method 1300 may include receiving, from the remote server device, display instructions for displaying a graphical interface populated using travel data (block 1310). The travel data may be stored in a travel database and retrieved according to the instructions for the graphical interface. The method 1300 may include receiving, from the remote server device, instructions for displaying a graphical interface populated with a travel itinerary (block 1312). The travel itinerary may be associated with the travel guest profile. The travel itinerary may be initially empty. The travel itinerary may be populated with initial recommendations received at the remote server device from a user device associated with the travel agent profile. The recommendations may be based on one or more preferences reflected in the travel guest profile. The travel itinerary may be automatically populated with the recommendations based on the preferences reflected in the travel guest profile.

The method 1300 may include displaying, at the user device, the graphical interface for the travel data according to the received instructions (block 1314). The method 1300 may include receiving, at the user device and via the graphical interface for the travel data, an input that corresponds to selection of particular travel data (block 1316). The method 1300 may include, in response to receiving the input, automatically updating the instructions for displaying the travel itinerary graphical interface (block 1318). The instructions may be updated so that the selected travel data is included in the travel itinerary when displayed via the graphical interface at the user device.

The method 1300 may include receiving, from the remote server device and at the user device, additional selected travel data (block 1320). The additional selected travel data may be selected by a user associated with the profile that is paired with the user profile of the present user device. The method 1300 may include, in response to receiving the additional selected travel data, updating the instructions for displaying the travel itinerary graphical interface so that the travel itinerary includes the additional selected travel data (block 1322). The method 1300 may include displaying, at the user device, the travel itinerary graphical interface (block 1324). The graphical interface may include the travel data selected at the user device and/or the additional travel data selected at the other user device.

The user device may be associated with the travel agent profile (e.g., may be a travel agent device). The graphical interface for the travel itinerary, when associated with the travel agent profile, may include a graphical commissions calculator. The graphical commissions calculator may display an agent commission based on the travel itinerary. The agent commission may be broken down and/or displayed according to specific selected travel data. For example, the travel itinerary graphical interface for the travel agent profile may include a commission variable next to selected lodging data, another commission variable next to selected transportation data, and so forth. The travel itinerary graphical interface for the travel agent profile may include a total commission variable that sums commissions associated with various selected travel data.

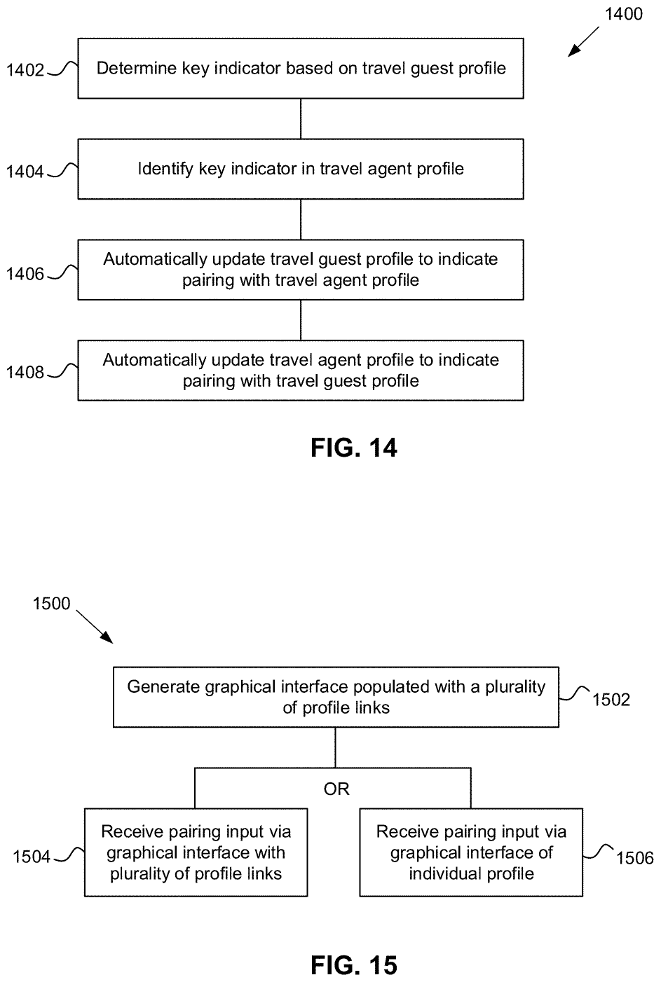

FIG. 14 illustrates a method 1400 for automatically pairing a travel agent profile and a travel guest profile, according to an embodiment. A travel guest may not be aware of criteria for selecting a travel agent or may not have time to browse and/or search travel agent profiles. The travel booking system may use the travel guest profile to automatically pair the travel guest with a travel agent, saving the travel guest time and generating leads automatically for the travel agent.

The method 1400 may include determining, based on the travel guest profile or the travel agent profile, a key indicator for pairing the two profiles (block 1402). The key indicator may be data (e.g., key indicator data) associated with the travel guest profile and/or the travel agent profile. The key indicator data may correspond to a home location associated with the travel guest profile being within a predefined range of a home location associated with the travel agent profile. The key indicator data may correspond to a travel type associated with the travel guest profile corresponding to a travel type specialty associated with the travel agent profile. The key indicator data may correspond to a travel destination associated with the travel guest profile being within a predefined range of the home location associated with the travel agent profile. The key indicator data may correspond to the travel destination associated with the travel guest profile being a specialty associated with the travel agent profile.

The key indicator may be a specification in the travel guest profile and/or the travel agent profile for pairing with a particular other user. For example, the key indicator data may correspond to the travel guest profile including a specific travel agent identifier. The travel agent identifier may include a username associated with the travel agent profile, a name of the user associated with the travel agent profile, or an identification number associated with the travel agent profile. The key indicator may be a specification in the travel guest profile for pairing with any agent of a particular agency. The key indicator may correspond to the travel agent profile including a specific travel guest identifier such as the travel guest's name and/or username.

The method 1400 may include identifying the key indicator in another user profile (block 1404). For example, the key identifier may be determined from a travel guest profile and identified in a travel agent profile. The key identifier may be determined from a travel agent profile and identified in a travel guest profile. The method 1400 may include automatically updating the travel guest profile to indicate pairing with the travel agent profile (block 1406). The method 1400 may include automatically updating the travel agent profile to indicate pairing with the travel guest profile (block 1408).

FIG. 15 illustrates a method 1500 of browsing a plurality of profiles, according to an embodiment. In some cases, a user such as a travel guest may be initially uncertain on how to judge a travel agent to decide which travel agent to pair with. The travel booking system may enable the travel guest to browse travel agent profiles without regard to any particular search criteria so that the travel guest may become familiar with different profiles and narrow down which travel agent to pair with.

The method 1500 may include generating, for display at a user device, a graphical interface populated with a set of profile links (block 1502). The profile links may correspond, respectively, to a plurality of travel agent profiles (e.g., when the user device is associated with a travel guest profile). The profile links may correspond, respectively, to a plurality of travel guest profiles (e.g., when the user device is associated with a travel agent profile).

The method 1500 may include receiving a pairing input via the graphical interface populated with the set of profile links (block 1504). The graphical interface for the set of profile links may include a variable, manipulable by the user, that automatically triggers pairing of the user profile with the selected profile when the profile is selected. The graphical interface for the set of profile links may also include a link that directs the user device to a subsequent graphical interface specific to an individual user profile or travel agency profile. The subsequent graphical interface may be a separate graphical container displayed next to the graphical interface populated with the plurality of profile links. The subsequent graphical interface may pop at least partially over the graphical interface populated with the plurality of profile links. The subsequent graphical interface may be populated with the variable for triggering pairing of the user profile with the user profile. The method 1500 may include receiving the pairing input via the subsequent graphical interface specific to the individual user profile (block 1506).

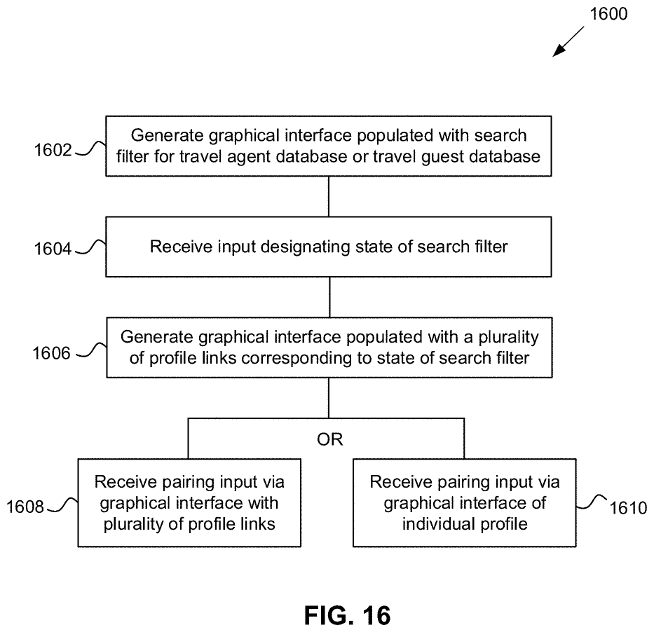

FIG. 16 illustrates a method 1600 of searching a set of user profiles using a search filter, according to an embodiment. In some cases, a user may prefer certain criteria for pairing with another user profile without knowing which profile, specifically, to pair with. The user may know the criteria associated with the specific profile the user wishes to pair without knowing the username or other direct information about the profile. Filtered searching may allow the user to browse a more targeted group of other users to identify which user to pair with.

The method 1600 may include generating, for display at a user device (e.g., the travel guest device and/or the travel agent device), a graphical interface populated with a search filter for searching a user database (block 1602). For example, a graphical interface may be generated for displaying, at the travel guest device, a search filter for searching the travel agent database. The search filter may be a location-based filter, a travel specialty filter, a destination filter, an availability filter (e.g., which travel agent profiles indicate a travel agent user is available to work with additional travel guests), and so forth.

The method 1600 may include receiving, from the user device via the graphical interface, a filter input (block 1604). The filter input may correspond to a designation of a state of the search filter. The method 1600 may include, in response to receiving the filter input, generating, for display at the user device, a graphical interface populated with profile links (block 1606). The graphical interface may be populated from a user database such as a travel agent database and/or a travel guest database. The profile links may correspond to a plurality of profiles selected automatically based on the state of the search filter. The method 1600 may include receiving a pairing input via the graphical interface populated with the set of profile links (block 1608). The method 1600 may include receiving the pairing input via another graphical interface generated in response to an individual profile link being selected (block 1610).

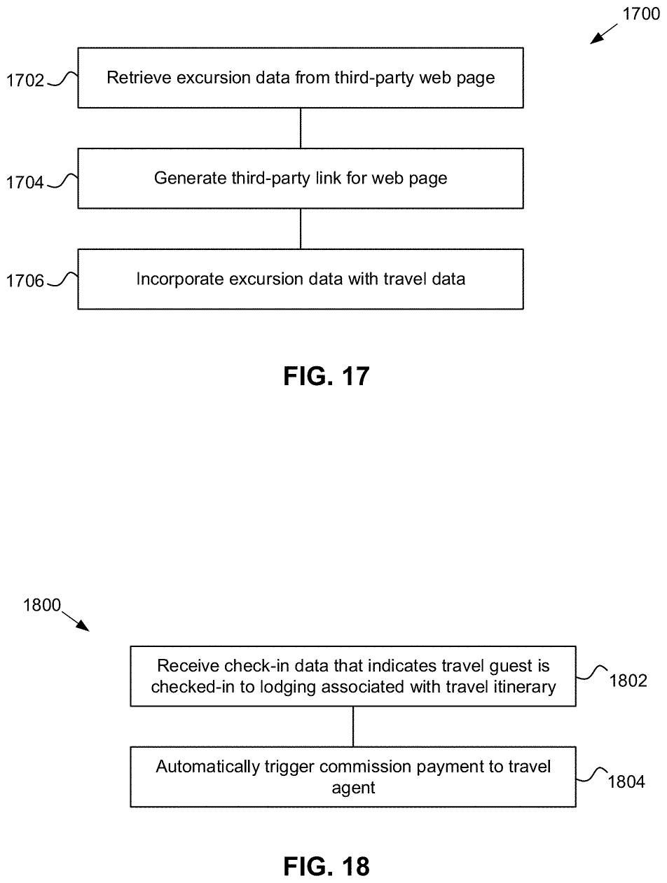

FIG. 17 illustrates a method 1700 of adding third-party excursion data to travel data in the travel booking system, according to an embodiment. A travel guest may wish to go on excursions during their vacation. A variety of providers may offer excursions and booking information may be available through various third-party websites not associated with the travel booking system. The travel booking system may automatically identify excursions available in the area where the travel guest wishes to vacation and may add that data to the travel data so that the travel guest can book the excursions when planning their vacation.

The method 1700 may include retrieving excursion data from a web page (block 1702). The web page may be owned and/or operated by a third party unaffiliated with the travel booking system. The web page may be owned and/or operated by an excursion provider. The web page may be owned and/or operated by another entity that compiles excursion data from others. In one example, a web scraper may be used to cull excursion data from the web page. The excursion data may include information such as a location, a time, a date, and/or a cost of the travel excursion. The excursion data may include image data and/or information about an activity engaged in during the excursion.

The method 1700 may include generating a third-party link for the web page associated with the excursion data (block 1704). The method 1700 may include incorporating the excursion data and the third-party link with the travel data (block 1706). The third-party link may be displayed in the graphical interface for the travel data. In response to the third-party link being selected, the web page may be displayed on the user device displaying the graphical interface with the travel data.

The excursion data may be stored in an excursion database. The excursion database may include entry slots for information about the excursion, a location of the excursion, and/or the third-party link. The instructions for generating the graphical interface for the travel data may include retrieving third-party links for excursion data with the same location data as is associated with particular travel data (e.g., lodging data). The third-party link may be displayed with the travel data in the graphical interface. The graphical interface for the travel data may include a link to a separate graphical interface where the excursion data is displayed. The separate graphical interface for the excursion data may be a pop-over container or may be a new page.

FIG. 18 illustrates a method 1800 of automatically disbursing a travel agent commission, according to an embodiment. A travel provider such as a vacation rental owner or a transportation provider may incentivize travel agents to direct travel guests to their services by providing commissions to the travel agent. To ensure that the services are actually paid-for and used by the travel guest, the provider may withhold commissions until use by the travel guest of the services is confirmed. The travel booking system enables automatic commission payment when, for example, the travel guest checks in to their booked lodging. This allows the travel agent and the providers to both ensure they are paid in a prompt and simple manner for the services they provide.

The method 1800 may include receiving check-in data from a travel guest device (block 1802). The check-in data may indicate a user associated with the travel guest profile has checked in to lodging associated with the travel itinerary associated with the travel guest profile. The check-in data may indicate the user has checked-in for their flight. The check-in data may indicate the user has arrived for their excursion or dinner reservation. The method 1800 may include, in response to receiving the check-in data, automatically triggering a commission payment (block 1804). The commission payment may be made to a user associated with the travel agent profile that is, in turn, associated with the travel itinerary. Triggering the commission payment may include instructions associated with releasing funds from a bank account such as an account holding travel funds from the travel guest. The instructions may direct payment to a bank account owned by the travel agent.

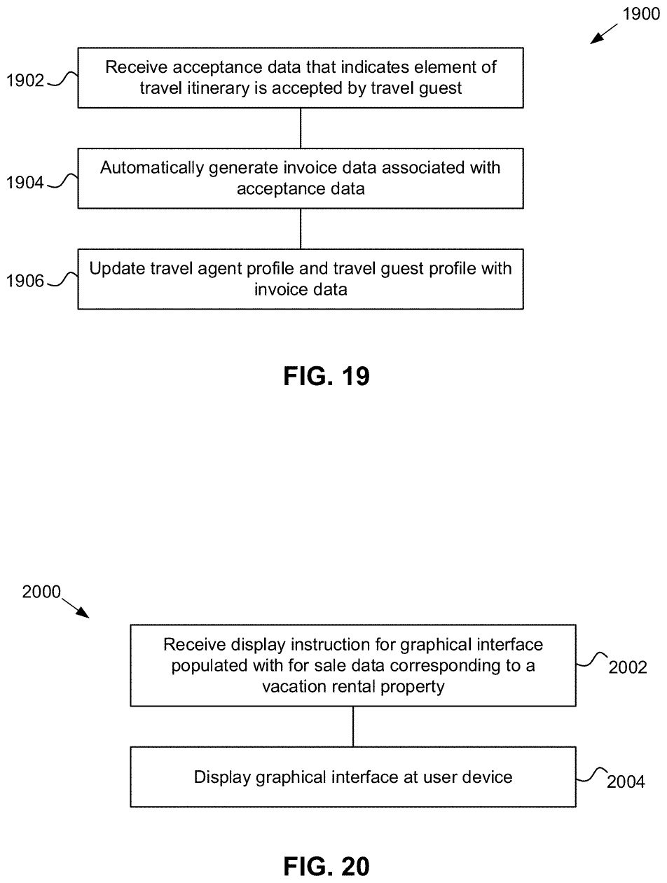

FIG. 19 illustrates a method 1900 of automatically generating an invoice when at least a portion of a travel itinerary is confirmed, according to an embodiment. The travel booking system allows for travel itinerary items added by the travel agent or the travel guest to be invoiced directly from the travel itinerary. This saves the travel agent time, particularly when the travel guest takes a more active part in building the travel itinerary.

The method 1900 may include receiving acceptance data that indicates at least one element of a travel itinerary is accepted by a user associated with the travel guest profile (block 1902). The acceptance data may represent a confirmation, by the travel guest, that they desire to have the element of the travel itinerary included and are ready to pay for the element. The acceptance data may correspond to a specific element of the travel itinerary or may correspond to multiple elements of the travel itinerary. The acceptance data may correspond to the entire travel itinerary. The acceptance data may be received at a remote server device from the travel guest device. The acceptance data may be received at the travel agent device from the remote server device.

The method 1900 may include, in response to receiving the acceptance data, automatically generating invoice data associated with the acceptance data (block 1904). The invoice data may include an identifier for the element of the travel itinerary. The invoice data may include price data for the element of the travel itinerary. The method 1900 may include updating the travel agent profile and/or the travel guest profile with the invoice data (block 1906).

FIG. 20 illustrates a method 2000 of listing a vacation rental property for sale in the travel booking system, according to an embodiment. The travel booking system may collect data for specific vacation rental properties related to the profitability of the vacation rental property. When the owner wishes to sell the property, the data can be leveraged to entice buyers and provide a complete picture of the potential future profitability of the vacation rental for a buyer.

The travel data associated with a particular vacation rental property may indicate the property is being offered for sale. The method 2000 may include receiving, from the remote server device, display instructions for displaying a graphical interface populated with for sale data corresponding to a particular vacation rental property (block 2002). The method may include displaying, at a user device, the graphical interface according to the display instructions (block 2004).

The for sale data may be received at the travel guest device, at the travel agent device, and/or at a buyer device associated with a buyer profile of the travel booking system. The for sale data may include booking history data for the vacation rental property. The booking history data may indicate how frequently the property is booked in the travel booking system, when the busiest seasons are for the property, and/or when the slowest seasons are for the property.

The for sale data may include profitability data for the vacation rental property. The profitability data may include how much has been previously charged for bookings, how much annual rental revenue is generated by the property, costs associated with maintaining the property, taxes on the property, and so forth. The profitability data may compare the rental revenue to the maintenance costs and/or other costs associated with the property to determine a likely profitability of the property as a short-term vacation rental. The profitability data may be based on booking data for bookings through the travel booking system. Some of the profitability data may be scraped from another system where the property is booked as a vacation rental. The profitability data may be based on additional data input into the travel booking system by a user associated with a seller profile for the vacation rental property.

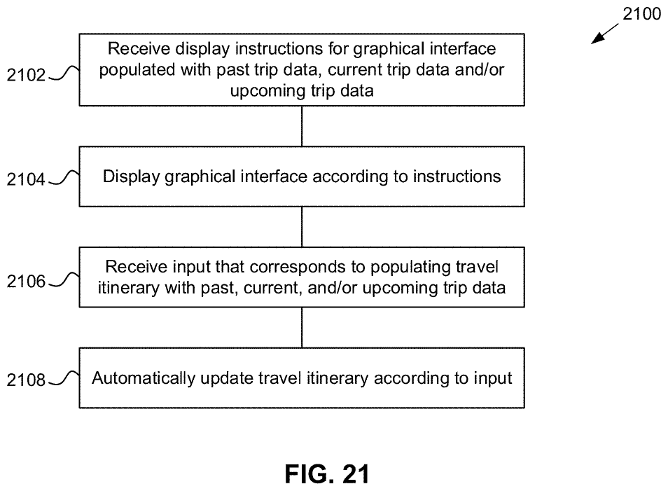

FIG. 21 illustrates a method 2100 of using other trips booked by a travel agent to fill a current travel itinerary, according to an embodiment. One way that travel agents generate business is through referrals from satisfied customers. A new travel guest may be enticed by a previous travel guest's experience to have the travel agent book a similar vacation for the new travel guest. The travel booking system stores and displays previous, current, and/or upcoming trips booked by the travel agent. The travel agent may import another travel itinerary to a new travel itinerary to same time and make sure the new travel guest still gets the best prices for their vacation. The travel guest may see the past, current, and/or upcoming trips booked by the travel agent and select a trip to populate the travel itinerary associated with the travel guest profile.

The method 2100 may include receiving, from a remote server device, display instructions for displaying a graphical interface populated using the travel agent profile (block 2102). The travel agent profile may include past trip data that corresponds to a past trip associated with the travel agent profile (e.g., a past trip booked by the travel agent). The travel agent profile may include current trip data that corresponds to a current trip associated with the travel agent (e.g., a trip that is in-progress and was booked by the travel agent). The travel agent profile may include upcoming trip data that corresponds to an upcoming trip associated with the travel agent profile (e.g., an upcoming trip booked by the travel agent). The upcoming trip data may be useful, for example, when the travel guest associated with the upcoming trip data wishes to add another guest to their party. The past, current, and/or upcoming trip data may be in the form of a booked travel itinerary.

The method 2100 may include displaying, at a user device such as the travel agent device, the graphical interface according to the received instructions (block 2104). The method 2100 may include receiving, via the graphical interface, an input that corresponds to populating a travel itinerary with the past trip data, the current trip data, and/or the upcoming trip data (block 2106). The travel itinerary may be associated with a new travel guest profile paired with the travel agent profile. The travel itinerary may be a provisional itinerary used as a promotion to entice a travel guest to pair with the travel agent. The method 2100 may include automatically updating the travel itinerary according to the input (block 2108).

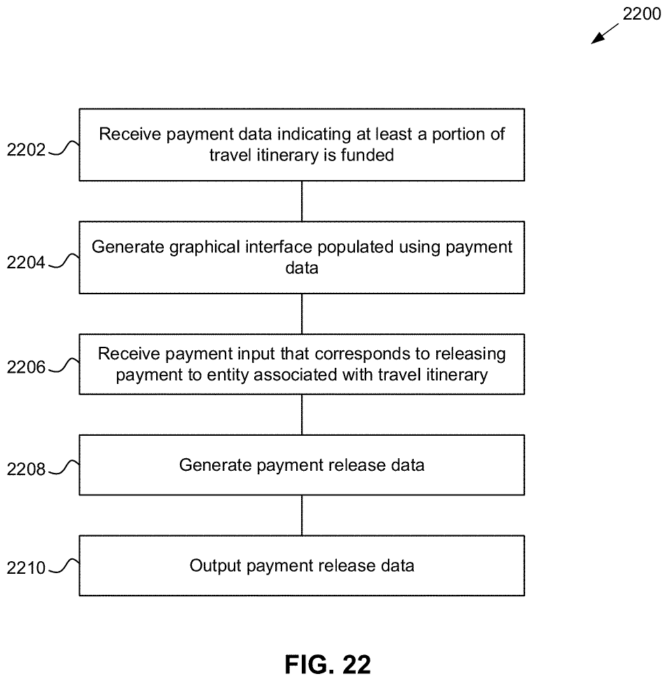

FIG. 22 illustrates a method 2200 of generating payment data to pay various entities associated with a travel itinerary, according to an embodiment. The travel booking system may allow a travel guest to pay a single entity, such as the travel agency, a single payment or multiple payments to cover the costs associated with the travel itinerary. In turn, the travel booking system may automatically release payment for the bookings to the entities providing the services associated with the travel itinerary. This may reduce bookkeeping time for travel agents and/or may reduce the amount of time it takes for providers to get paid. Overall, this may decrease the amount of time for planning and booking a vacation.

The method 2200 may include receiving payment data that indicates at least a portion of a travel itinerary is funded (block 2202). The payment data may be received at the remote server device from the travel guest device. The payment data may be received at the remote server device from a financial institution server. The payment data may be received at the travel agent device and/or at the travel guest device from the remote server (e.g., the remote server may forward the payment data to the travel guest device and/or the travel agent device). The method 2200 may include, in response to receiving the payment data, generating a graphical interface populated using the payment data (block 2204).

The method 2200 may include receiving, via the graphical interface populated using the payment data, a payment input that corresponds to releasing payment to an entity associated with the travel itinerary (block 2206). For example, the travel agent device may receive the payment data. The travel agent may see in the graphical interface that payment from the travel guest has been received. The travel agent may generate, via the graphical interface, payment to one or more entities or providers associated with the travel itinerary from the funds received for the travel itinerary.

The method 2200 may include, in response to receiving the payment input, generating payment release data that corresponds to releasing payment to the provider or entity (block 2208). The payment release data may be, for example, instructions to be transmitted to a financial institution server to transmit payment information to a financial institution server associated with the provider/entity. The method 2200 may include outputting the payment release data, such as to the remote server device (block 2210). The remote server device may cause the payment release data to be forwarded to the financial institution server.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

We claim:

1. A system, comprising:
a travel agent device;
a travel guest device;
a processing device; and
a memory device coupled to the processing device, the memory device storing executable instructions that are executable by the processing device to:
receive, from the travel agent device, travel agent data that corresponds to information about a travel agent;
establish, based on the travel agent data, a travel agent profile;
receive, from the travel guest device, travel guest data that corresponds to information about a travel guest;
establish, based on the travel guest data:
a travel guest profile; and
a travel itinerary for the travel guest, wherein the travel itinerary initially comprises an empty data set;
receive, from the travel agent device or the travel guest device, a pairing input indicating the travel agent is associated with the travel guest;
generate, for display at the travel agent device or the travel guest device, a first graphical interface populated with the travel itinerary;
generate, for display at the travel agent device or the travel guest device, a second graphical interface populated with travel data;
receive, from the travel agent device or the travel guest device, a selection input corresponding to a selection associated with selected travel data;
automatically update the travel itinerary with the selected travel data; and
output, to the travel agent device or the travel guest device, the first graphical interface populated with the travel itinerary, wherein the travel itinerary comprises the selected travel data.

2. The system of claim 1, the executable instructions further to generate, for display at the travel guest device, a third graphical interface populated with a set of links, wherein:
the set of links comprises:
a first link that corresponds to a first set of instructions for automatically pairing a travel guest profile with an individual travel agent profile;
a second link that corresponds to a second set of instructions for presenting, in the second graphical interface at the travel guest device, a travel agent data set corresponding to a plurality of travel agent profiles; and
a third link that corresponds to a third set of instructions for searching a travel agent database based on a search filter; and
the pairing input corresponds to selection of the first link, the second link, or the third link.

3. The system of claim 2, the first set of instructions executable by the processing device to:
determine, based on the travel guest profile, a key indicator for pairing the travel guest profile with the travel agent profile;
identify the key indicator in the individual travel agent profile;
automatically update the travel guest profile to indicate pairing with the travel agent profile; and
automatically update the travel agent profile to indicate pairing with the travel guest profile.

4. The system of claim 2, the second set of instructions executable by the processing device to generate, for display at the travel guest device, a fourth graphical interface populated with a set of profile links, wherein:
the set of profile links comprises a first profile link and a second profile link;
the first profile link corresponds to a first travel agent profile;
the second profile link corresponds to a second travel agent profile;
the pairing input is received:
via the fourth graphical interface by selection of the first profile link or the second profile link; or
via a fifth graphical interface generated in response to selection of the first profile link or the second profile link.

5. The system of claim 2, the third set of instructions executable by the processing device to:
generate, for display at the travel guest device, a fourth graphical interface populated with the search filter for searching the travel agent database;
receive, from the travel guest device and via the fourth graphical interface, a filter input corresponding to a designation of a state of the search filter; and
in response to receiving the filter input, generate, for display at the travel guest device, a fifth graphical interface populated, from the travel agent database, with a set of profile links corresponding, respectively, to a plurality of travel agent profiles selected based on the state of the search filter,
wherein the pairing input is received:
via the fifth graphical interface by selection of an individual profile link; or
via a sixth graphical interface that is generated in response to selection of the individual profile link.

6. The system of claim 1, wherein the travel data comprises:
date data that corresponds to a travel date;
transportation data that corresponds to travel transportation;
destination data that corresponds to a travel destination;
lodging data that corresponds to travel lodging; or
excursion data that corresponds to a travel excursion.

7. The system of claim 6, wherein the lodging data comprises:
information about renting specific lodging short-term; or
information about purchasing the specific lodging.

8. The system of claim 1, the executable instructions further to:
retrieve, from a web page associated with a third-party excursion provider, excursion data corresponding to a location, a time, a date, or a cost of a travel excursion;
generate a third-party link for the web page associated with the third-party excursion provider; and
incorporate the excursion data and the third-party link with the travel data, wherein, in response to the third-party link being selected, the web page is displayed on the travel agent device or the travel guest device.

9. The system of claim 1, the executable instructions further to:
receive, from the travel guest device, check-in data that indicates a user associated with the travel guest profile has checked in to lodging associated with the travel itinerary; and
in response to receiving the check-in data, automatically trigger a commission payment to a user associated with the travel agent profile.

10. The system of claim 1, wherein:
the travel guest profile comprises a travel preference of a user associated with the travel guest profile; and
the travel data displayed at the travel agent device in the second graphical interface is filtered according to the travel preference.

11. The system of claim 1, the executable instructions further to:
receive, from the travel guest device, acceptance data that indicates at least one element of the travel itinerary is accepted by a user associated with the travel guest profile;
in response to receiving the acceptance data, automatically generate invoice data associated with the acceptance data; and
update the travel agent profile and the travel guest profile with the invoice data.

12. A system, comprising:
a processing device; and
a memory device coupled to the processing device, the memory device storing executable instructions that are executable by the processing device to:
receive, from a remote server device, a first display instruction for displaying a first graphical interface, wherein:
the first graphical interface is populated with a link that corresponds to a pairing instruction; and
the pairing instruction is executable at the remote server device for pairing a travel guest profile with a travel agent profile;
display, at a travel guest device associated with the travel guest profile, the first graphical interface;
receive, via the first graphical interface, a first input that corresponds to pairing of the travel guest profile with the travel agent profile;
output, to the remote server device, the pairing instruction based on the first input;
receive, from the remote server device, a second display instruction for displaying a second graphical interface populated using travel data;
receive, from the remote server device, a third display instruction for displaying a third graphical interface populated with a travel itinerary associated with the travel guest profile, wherein the travel itinerary initially comprises an empty data set;
display, at the travel guest device, the second graphical interface according to the second display instruction;
receive, via the second graphical interface, a second input that corresponds to first selected travel data;
in response to receiving the second input, automatically update the third display instruction so that the first selected travel data is included in the travel itinerary;
receive, from the remote server device, second selected travel data, wherein the second selected travel data is selected by a user associated with the travel agent profile that is paired with the travel guest profile;
in response to receiving the second selected travel data, automatically update the third display instruction so that the travel itinerary comprises the second selected travel data; and
display, at the travel guest device, the third graphical interface, wherein the travel itinerary comprises the first selected travel data or the second selected travel data.

13. The system of claim 12, wherein the pairing instruction is executable to:
automatically pair the travel guest profile with the travel agent profile based on key indicator data;
enable browsing, at the travel guest device, of a set of travel agent profiles; or
enable filtered searching, at the travel guest device, of the set of travel agent profiles.

14. The system of claim 13, wherein the key indicator data corresponds to:
a home location associated with the travel guest profile being within a predefined range of a home location associated with the travel agent profile;
a travel type associated with the travel guest profile corresponding to a travel type specialty associated with the travel agent profile; or
a travel destination associated with the travel guest profile being within a predefined range of the home location associated with the travel agent profile.

15. The system of claim 13, wherein the key indicator data corresponds to the travel guest profile comprising a travel agent identifier, wherein the travel agent identifier comprises:
a username associated with the travel agent profile;
a name of the user associated with the travel agent profile; or
an identification number associated with the travel agent profile.

16. The system of claim 12, wherein the travel data comprises an indication that a vacation rental property is being offered for sale, the executable instructions further executable by the processing device to:
receive, from the remote server device, a fourth display instruction for displaying, at the travel guest device, a fourth graphical interface populated with for sale data corresponding to the vacation rental property, wherein the for sale data comprises:
booking history data corresponding to the vacation rental property; and
profitability data corresponding to the vacation rental property; and
display, at the travel guest device, the fourth graphical interface according to the fourth display instruction.

17. A system, comprising:
a processing device; and
a memory device coupled to the processing device, the memory device storing executable instructions that are executable by the processing device to:
receive, from a remote server device, a first display instruction for displaying a first graphical interface, wherein:
the graphical interface is populated with pairing data for pairing a travel agent profile with a travel guest profile; and
the pairing data is based on a request associated with the travel guest profile to pair with travel agent profile;
display, at a user device, the first graphical interface;
receive, via the first graphical interface, a first input that corresponds to pairing of the travel guest profile with the travel agent profile;
output, to the remote server device, a pairing instruction based on the first input, wherein the pairing instruction, when executed by the remote server device, updates the travel agent profile and the travel guest profile to indicate the travel agent profile and the travel guest profile are paired;
receive, from the remote server device, a second display instruction for displaying a second graphical interface populated using travel data;
receive, from the remote server device, a third display instruction for displaying a third graphical interface populated with a travel itinerary associated with the travel guest profile, wherein the travel itinerary initially comprises an empty data set;
display, at the user device, the second graphical interface according to the second display instruction;
receive, via the second graphical interface, a second input that corresponds to first selected travel data;
in response to receiving the second input, automatically update the third display instruction so that the first selected travel data is included in the travel itinerary;
receive, from the remote server device, second selected travel data, wherein the second selected travel data is selected by a user associated with the travel guest profile or a user associated with the travel agent profile;
in response to receiving the second selected travel data, automatically update the third display instruction so that the travel itinerary comprises the second selected travel data; and
display, at the user device, the third graphical interface, wherein the travel itinerary comprises the first selected travel data or the second selected travel data.

18. The system of claim 17, wherein:
the user device is associated with the travel agent profile; and
the executable instructions further executable by the processing device to:
receive, from the remote server device, a fourth display instruction for displaying, at the user device, a fourth graphical interface populated using the travel agent profile, wherein the travel agent profile comprises:
past trip data corresponding to a past trip associated with the travel agent profile;
current trip data corresponding to a current trip associated with the travel agent profile; and
upcoming trip data corresponding to an upcoming trip associated with the travel agent profile;
display, at the user device, the fourth graphical interface according to the fourth display instruction;
receive, via the fourth graphical interface, a third input that corresponds to populating the travel itinerary with the past trip data, the current trip data, or the upcoming trip; and
automatically update the travel itinerary according to the third input.

19. The system of claim 17, wherein the third graphical interface is further populated with a graphical commissions calculator for displaying an agent commission based on the travel itinerary.

20. The system of claim 17, the executable instructions further to:
receive, from the remote server device, payment data indicating at least a portion of the travel itinerary is funded;
in response to receiving the payment data, generate a fourth graphical interface that is populated using the payment data;
receive, via the fourth graphical interface, a payment input that corresponds to releasing payment to an entity associated with the travel itinerary;
in response to receiving the payment input, generate payment release data that corresponds to releasing payment to the entity associated with the travel itinerary; and
output, to the remote server device, the payment release data.
